(19) United States
(12) Patent Application Publication
(10) Pub. No.: US 2025/0195971 A1
(43) Pub. Date: Jun. 19, 2025

(54) HYBRID BASEBALL BAT AND CONSTRUCTION METHODS

(71) Applicants: Steven John Benda, Cokato, MN (US); Logan James Benda, Cokato, MN (US); Peter James Kruse, Delano, MN (US); Adam Robert Loukus, Calumet, MI (US)

(72) Inventors: Steven John Benda, Cokato, MN (US); Logan James Benda, Cokato, MN (US); Peter James Kruse, Delano, MN (US); Adam Robert Loukus, Calumet, MI (US)

(21) Appl. No.: 19/067,384

(22) Filed: Feb. 28, 2025

Related U.S. Application Data
(63) Continuation of application No. 17/835,701, filed on Jun. 8, 2022.
Application No. 17/835,701 is a continuation of application No. 16/865,302, filed on May 1, 2020, now Pat. No. 11,395,945.
(60) Provisional application No. 62/920,477, filed on May 1, 2019.

(51) Int. Cl. A63B 59/52; A63B 59/58; A63B 102/18; B27M 1/08; B27M 3/22

(52) U.S. Cl. CPC A63B 59/52; A63B 59/58; B27M 1/08; B27M 3/22; A63B 2102/18; A63B 2209/02; A63B 2209/10

(57) ABSTRACT

Disclosure herein are various forms of hybrid baseball bats comprising a wood shell having a radial wall and an outer radial surface profile defining a baseball bat. The wood shell having a central core with a central surface thereon extending from a distal end of the bat to the proximal end of the bat. The central surface being profiled with a taper that in some embodiments extends entirely through to the proximal end. A fibrous construct is housed in the central core and infiltrated with an epoxy resin for strength, shape adherence and bonding to the central surface. Disclosed are various manufacturing techniques for manufacturing hybrid bats including resin epoxy infiltration from removable or permanent core forced volume displacement means and/or high-pressure two-part epoxy injection means.

### CROSS REFERENCE TO RELATED APPLICATIONS

This Continuation-In-Part Patent application claims priority to Continuation patent application Ser. No. 17/835,701 filed Jun. 8, 2022 which claims priority to Non-Provisional patent application Ser. No. 16/865,302 filed May 1, 2020 which claims the benefit of Provisional Patent Application No. 62/920,477 filed May 1, 2019, the entire disclosures of which are hereby incorporated by reference and relied upon.

### BACKGROUND OF THE INVENTION

### Field of the Invention

The invention relates generally to baseball bats, and more particularly to high performance baseball bats having a hybrid material construction.

### Description of Related Art

Baseball bat design over the years has gone through many forms of iterations due to availability of various viable materials of construction and evolution of manufacturing machine capabilities but mostly due to certification requirements and restrictions. The Major League Baseball (MLB) organizations started with wood bats and still use wood bats to maintain the “Original Gamer” integrity of the game of baseball. Other materials like metal were introduced into the game of baseball around 1924 in attempts to enable the younger players the ability to perform at higher levels. Over the years baseball bats materials have progressed through many phases such as aluminum construction, two-part composite construction, full composite construction, wood plus external composite construction, multi-component bats using aluminum, wood, hybrid composites or combinations thereof and wood plus laminate construction. As the bat performance was increasing, the restrictions also increased to ensure safety of the final bat product. Past restrictions were based on a BESR (Ball Exit Speed Ratio). Based on bat performance increasing over time, new (and current) standards were adopted for youth (USABat Certification) and Youth to College BBCOR: Bat-Ball Coefficient of Restitution. These testing developments and material developments have increasingly driven the cost of a baseball bat up, bringing the highest end bat cost to around $500 as of 2023. Although testing for full metal and composites bats is relatively standard, the same certification standards for wood bats are more difficult. Starting wood billets used to create a standard wood bat that meets the strict BBCOR requirements are as much as three times more expensive than a heavier wood billet. Also, to meet weight requirements, a 21/2″ diameter barrel is often used in wood bats. In commercially available hybrid bat models (ex: MarucciR AP5 Hybrid Pro Model, DeMariniR D110 and D243 Pro Maple Composite, and Axe Bats™ Poro Maple Composite Wood Hubrid L180) the method used to achieve a 21/8″ diameter barrel size while meeting the weight requirements is by use of a two-piece construction including a barrel and a composite handle. This construction method introduces a weak point in the design of adjoining surfaces. Higher performing bats in the prior art commonly utilize bat construction have two laminated pieces of wood with pre-made carbon inserts added for strength. This design leads to reduced strength through laminated pieces and weaker sidewalls due to single axis drilling. The end result is less weight control due to extraneous materials, more difficult acceptable certification testing all causing less quality control, lower baseball rebound, loss of flexibility all due to the remaining wood. In addition, high performance bats of the prior art commonly utilize a pre-formed approximately 2 inch diameter carbon filter sleeve which fits over a uniform diameter cylindrically drilled hole down the core of the bat. This design approach creates two main problems in the performance and strength of a hybrid bat. The first problem is strength, since a baseball bat design tapers from at most a 2⅝″ OD at the distal end of the bat to a smaller diameter at the thinnest point in the handle. This cylindrical hole creates a concentrated stress point internally which may cause a delamination and premature fracture in the bat structure. Additionally, this non-profiled barrel wall thickness introduces a reduction in the “Sweet Spot” of the bat.

As noted in the hybrid bat design of the prior art, the internal core responsible for a better sweet spot is relatively small (approximately 6-8″ max). This problem is a consequence of the use of a pre-formed cylindrical sleeve. To rectify this problem, additional support is added in the core to ensure maximum strength. The additional support adds weight and minimizes the area that the internal chamber can span. This configuration creates a trampoline effect for the baseball to rebound off upon impact.

Composite bat designs of the prior art are created through a two-piece construction process that joins a handle and barrel. This approach is used to reduce handle vibrations while improving barrel performance. Hybrid bats in the prior art also build bats with two-piece construction, however their designs require a large amount of internal support and binding to merge the barrel to the handle. Namely, this is done through laminating a complete carbon fiber or plastic handle to the wood barrel portion of the bat. There are many different shortfalls in this approach including the use of extraneous materials eliminating full ability overweight distribution and control, discontinuous barrel and handle, prefabricated handle, and minimal bonding surface.

What is needed is a hybrid fusion wood bat having the largest allowable barrel (2⅝″ diameter) that is consistent in diameter along a much larger “Sweet Spot”. Along with the advantages identified in Patent #: 11,395,945 B2, this hybrid fusion wood bat will have vibration dampening characteristics as an integral part of the high strength internal fibrous construct. Also needed is for the wood baseball bat core to provide added safety measures to prevent separation of the bat handle portion from the barrel portion in the event of bat breakage. The needed bat must perform at or near the present BBCOR standard to match composite bats performance all at an affordable price. What is needed is a unique hybrid fused wood/composite bat design and novel methods of manufacturing to create it.

### SUMMARY OF THE INVENTION

Disclosed herein are various forms of a novel hybrid baseball bat along with novel methods of construction for the hybrid baseball bat. In preferred forms the novel hybrid baseball bat is compatible with certification requirements established for baseball bats used in competition. Although easy for full metal and composite bats, these certification requirements are difficult to achieve for wood bats. Various forms of the novel hybrid baseball bat described herein remove large amounts of core material from the originating wood billet. Thus, this hybrid fusion bat can also meet USA Bat requirements and reach −10, −8, and −5 drop weights while maintaining the 2⅝″ big barrel. Bats disclosed herein are the first to utilize a heavy billet to achieve a −3 (and −5, −8, and −10 drop weight) bat through our material removal processes and have created a bat which has higher wood density and surface hardness. These features translate to greater bat strength and baseball acceleration (rebound) off the bat when used in hitting. A variety of manufacturing methods are introduced which provide improved bat performance compared to inferior manufacturing methods used in the prior art which comprise the method of inserting an already complete handle built from preformed carbon tubes. Manufacturing methods disclosed herein create a continuous internal support, eliminate all extraneous material, and provide for a maximized handle to barrel bonding surface, all of which are novel improvements to the current methods.

Baseball is a historic pastime. Many things make it so, including the smells, atmosphere, tradition, but also the sounds including the crack of a bat upon impact with a baseball. Composite and metal bats of today used in the youth baseball levels cannot recreate that iconic crack. The hybrid baseball bat designs disclosed herein cannot create the exact wood bat sound, however, the disclosed bats have the largest cavity formed inside the barrel of a wood bat. Upon impact with a baseball, this large wood cavity with the internal support as described herein recreates a very similar rich sound of wood bats.

In one form, the hybrid baseball bat comprises a variety of materials including but not limited to wood such as maple and birch.

In one form, the hybrid baseball bat comprises a variety of materials including but not limited to composites such as carbon fiber, resins such as epoxies, fiberglass, and Kevlar.

In one form, the hybrid baseball bat comprises a composite having high strength fibers.

In one form, the hybrid baseball bat comprises an epoxy such as a two-part epoxy to bind high strength fibers to wood.

In one form, the high strength fibers are arranged in a fibrous construct as one or more of the following: a weave, a fibrous sleeve, and a mesh by one or more of spraying and direct fiber arrangement.

In one form, the high strength fibers used in the hybrid bat are arranged as a weave and can be varied in weave type, weave direction, weave thread count, weave thickness, and weave layers to produce a desired hybrid bat performance characteristic such as bat weight, bat center of gravity, bat stiffness, and bat ductility.

In one form, the type of two-part epoxy used in the hybrid bat is varied to produce a desired hybrid bat performance characteristic such as bat weight, bat center of gravity, bat stiffness, and bat ductility.

In one form, vibration dampening components and/or features are added to the high strength fiber/two-part epoxy assembly to produce desired hybrid bat vibration dampening characteristics to reduce ball-to-barrel impact induced vibrations that may transfer from the impact to the handle.

In one form, the vibration dampening component can be a pre-selected foam density core located in the central core area, a central core containing a polymer material at the transition area, a combination of a foam core with a vibration dampening polymer transition feature, and a central hybrid bat central core consisting of various parts of high strength fiber, two-part resin, flex rod core, and vibration dampening materials all joined together to form a hybrid high strength, vibration dampening baseball bat.

In one form, a vibration dampening ring is positioned on the hybrid bat around the external surface at or approximately at the area where the distal end of the handle transitions into the proximal end of the barrel sections. The vibration dampening ring consists of a material designed to reduce/eliminate translated vibration waves traveling along the external surface of the baseball bat from the bat-to-barrel impact point towards the handle proximal end to reduce/eliminate the vibration sting into the hitters' hands. In one form, a weave formed from high strength fibers is varied in diameter and shape through exertion of one or more of internal and external forces during the hybrid baseball bat manufacturing process.

In one form, a weave formed from high strength fibers is embedded in a wood shell of the hybrid bat by an outward radial force directed from a central axis of a wood shell. In some forms, the outward radial force is due to but not limited to: inflation of a central bladder (also termed expandable bladder or inflatable bladder), and centrifugal force as a consequence of high speed rotation of the wood shell along the central axis.

In one form, a hybrid baseball bat comprises a variety of materials including but not limited to plastics such as acetal, nylon, HDPE (high density polyethylene, PVC (polyvinyl chloride), PP (polypropylene), PS (polystyrene), and various TPEs (thermoplastic elastomeric), TPRs (thermoplastic rubbers) or any combination thereof.

In one form, the hybrid baseball bat vibration dampening components consists of two or more thermoplastic materials that are chemically compatible materials that can be thermally bonded. Examples being but not limited to Polypropylene/Santoprene and Hytrel/Alcryn.

In one form, combinations of thermoplastics with various hardness determinates (shore A or Shore D) are used to produce desired hybrid bat performance characteristics such as bat weight, bat vibration dampening, bat center of gravity, bat stiffness, and bat ductility.

In one form, a grip encircles a handle portion of the hybrid baseball bat for improved hand placement experience on the bat by a user.

In one form, the grip is in the form of a baseball bat grip tape for circumferentially wrapping around the radial wall of a handle portion or a grip sleeve that is positioned over the handle portion.

In one form, the hybrid baseball bat comprises materials from two or more of the following groups: woods, composites, and plastics.

In one form, the hybrid baseball bat is compatible with BBCOR and USABat certification requirements.

In one form, the hybrid baseball bat comprises: a bat barrel diameter not exceeding 2.625 inches, a length along a central axis ‘A’ not exceeding 34 inches, and a −3 drop weight (DW) as determined from bat length (BL) and weight (W, in ounces) where drop weight is calculated as DW=BL-W. For example, a 34 inch bat at a −3 drop weight weighs 31 ounces.

In one form, the hybrid baseball bat is manufactured from a wood billet that is substantially cylindrical.

In one form, the wood billet is greater than 34 inches and a diameter greater than 2.625 inches.

In one form, a wood billet is approximately 37 inches×2.8 inches.

In one form, a wood billet comprises a billet body and a first billet end and a second billet end.

In one form, an outer surface of a billet body is machined to create a profiled radial surface.

In one form, the profiled radial surface comprises an end, a barrel portion, a taper portion, a grip portion, and a knob portion.

In one form, the end is opposite the knob portion and the grip portion is intermediate the knob portion and taper portion.

In one form, the hybrid baseball bat comprises a proximal end where the knob portion terminates, and a distal end where the barrel portion terminates.

In one form, the hybrid baseball bat comprises a wood shell having a central core whereas said central core extends through the entire hybrid baseball bat from a distal end to a proximal end.

In one form, the hybrid baseball bat comprises a wood shell having a blind central core whereas said central core extends from a distal end into a portion of the handle portion.

In one form, the central core does not extend or only partially extends, through one or more of the knob portion and handle portion.

In one form, a central core of the hybrid bat is created by drilling using one or more drill bits leaving a remaining radial wall between the profiled radial surface (or outer surface of a billet body) and central surface.

In one form, the central core is created by a combined series of wood bits that are driven by one or more of a lathe and CNC machine.

In one form, the central core is created by wood bits in a gun drilling machine.

In one form, air pressure is introduced during gun drilling of the central core to remove wood chips and reduce heat buildup during cutting operations.

In one form, the wood bits utilized to create the central core include but are not limited to one or more of normal/standard, Forstner, gun drill, and CNC cutting bit.

In one form, the central core is profiled to maximize weight reduction and removing the stress concentration limitations of central cores having a constant diameter.

In one form, the central core comprises one or more of a barrel core, a taper core, a handle core, and a knob core formed in each of these respective areas of the hybrid bat.

In one form, the central core is describable in profile as but not limited to: uniform, variable, concave, and negative through any portion of the central core.

In one form, the hybrid baseball bat comprises a core structure comprising at least a plurality of high strength fibers infiltrated with an epoxy.

In one form, the high strength fibers are one of but not limited to carbon fiber, Kevlar, and other high strength materials.

In one form, the hybrid baseball bat comprises one or more centrifugally spun fiber sleeves adhered to the central surface of at least a portion of the central core.

In one form, the fiber sleeve is formed of one or more of carbon fiber, Kevlar, and other high strength materials.

In one form, the hybrid baseball bat comprises a flexible rod housed in the handle core of the handle portion for maximum strength and flexibility.

In one form, the hybrid baseball bat comprises a joining plug internally connecting the flexible rod to the fiber sleeve.

In one form, the hybrid baseball bat comprises a roughened central surface for maximum adhesion of the fiber sleeve.

In one form, the hybrid baseball bat design incorporates a profiled central surface on the radial wall as a base on which the fiber sleeve can adhere.

In one form, the profiled central surface of the radial wall is formed by use of a tapered drill bit driven by a lathe for example, whereby the outer face of the tapered drill bit comprises the complementing central surface contour.

In one form, the profiled central surface of the radial wall is formed by a wood bit driven by a CNC machine programmed to create the tapered profile of the central surface.

In one form, a drill bit extension is utilized along the same axis to drill partially into or through the handle portion of the hybrid baseball bat thereby creating a space to refill with a more flexible material than wood. This flexibility minimizes negative vibrations felt at any point of contact of the baseball on the bat and minimizes handle breakage.

In one form, a CNC lathe is used to shape the central surface of the radial wall based on a programmed profile. This method maximizes the barrel cavity while minimizing stress concentration points in the radial wall.

In one form, the hybrid baseball bat binds a flexible rod in the handle core and whereas a joining plug is fixed to one end of the flexible rod. This configuration maximizes handle portion strength, minimizes pre-mature handle fracture, provides increased handle portion flexibility, and minimizes negative handle vibrations.

In one form, a core structure is housed within the central core and is operable to add strength and support to the wood shell of a hybrid baseball bat.

In one form, the core structure comprises a formless fiber sleeve in a pre-finished configuration.

In one form, the fiber sleeve in the pre-finished configuration is flexible and can expand and contract as necessary to fit the profile of the central core as defined by the profiled central surface.

In one form, at least a portion of the central surface is roughened by one or more operations including but not limited to scouring, grooving, sanding, rifling, and other processes known in the art to ensure the tightest and strongest fit to the bat's internal walls.

In one form, a novel two-piece bat design is built using a bladder molded process. Using this approach, a handle portion of the hybrid baseball bat becomes one piece with the barrel portion. This configuration enhances strength, while maximizing barrel core performance.

In one form, a method of constructing a hybrid baseball bat comprises the following steps. Obtaining a wood billet. Trimming the wood billet to a predetermined length. Forming the profiled central surface of the central core using a machine operation such as one or more of but not limited to: gun drilling, wood bit boring, and drilling with tapered drill bit. Optionally, roughening the central surface by one or more operations such as rifling. Obtaining a flexible rod of a predetermined length and sized for housing in the handle core. Obtaining a joiner plug of a predetermined size for fit into the proximal end of the barrel core of the hybrid baseball bat. Fixing the joiner plug to one end of the flexible rod by inserting the flexible rod end into the plug aperture of the joiner plug. Obtaining a formless fibrous sleeve sized to house the joiner plug therein at one end and positioning the joiner plug in the fiber sleeve accordingly with the remaining flexible rod extending proximally away from the fibrous sleeve. Sliding the fibrous sleeve over the joining plug and attaching the fiber sleeve on an edge at the proximal end of the joining plug. Inserting the fibrous sleeve, joiner plug, and flexible rod assembly into the central core from the distal end. If necessary, radially opening the fibrous sleeve using a forming stick inserted down its internal chamber to approximate the outer face with the central surface of the wood shell. Removing the forming stick. Pouring an epoxy mix down the central core (alternatively, the fibrous sleeve and flexible rod may be pre-wetted with epoxy), Fixing the end cap at the distal end of the central core with adhesive (alternatively, the end cap may be inserted after epoxy curing operations depending on the requirements of the final operations in use). Adhering the fiber sleeve to the central surface of the central core by one of three methods: a low pressure bladder method, a high pressure bladder method, and a centrifugal force method as described in the following paragraphs.

In one form, a method of constructing a hybrid baseball bat comprises the following steps. Obtaining a wood billet. Trimming the wood billet to a predetermined length. Forming the profiled central surface of the central core using a machine operation such as one or more of but not limited to: gun drilling, wood bit boring, and drilling with tapered drill bit. Optionally roughening the central surface by one or more operations such as rifling, Obtaining a formless fibrous sleeve substantially the length of the central core. Inserting the fibrous sleeve into the central core from the distal end of the wood shell and aligning to cover the exposed central surface. If necessary, radially opening the fibrous sleeve using a forming stick inserted down its internal chamber to approximate the outer face with the central surface of the wood shell. Removing the forming stick. Pouring an epoxy mix down the central core (alternatively, the fibrous sleeve and flexible rod may be pre-wetted with epoxy). Fixing the end cap at the distal end of the central core with adhesive (alternatively, the end cap may be inserted after epoxy curing operations depending on the requirements of the final operations in use). Adhering the fiber sleeve to the central surface of the central core by one of three methods: a low pressure bladder method, a high pressure bladder method, and a centrifugal force method as described in the following paragraphs.

In the low pressure bladder method, the process begins with sliding an expandable bladder into the internal chamber of the fibrous construct (i.e. constructed as but not limited to: a weave, sprayed mesh, fibrous mesh, fibrous sleeve). Inflating the bladder thereby applying a low pressure (i.e. 10 psi) radial force that causes a consequent embedding of the fibrous sleeve in the central surface of the central core thus maximizing durability and minimizing potential delamination between the wood shell and sleeve during use (the radial wall operates as the mold walls for the curing fiber sleeve). Applying one or more optional measures such as heat and UV radiation to accelerate quality bonding. Removing the bladder after the epoxy cures. Fixing the end cap at the distal end of the central core with adhesives (if not done earlier). Then forming a preferred external profile of the hybrid bat utilizing a wood bit in a standard or CNC lathe. Alternatively, the step of forming an external profile of the hybrid baseball bat may be completed as an earlier step in the hybrid baseball bat forming process.

In the high pressure bladder method, the process begins with sliding an expandable bladder into the internal chamber of the fibrous construct (i.e. constructed as but not limited to: a weave, sprayed mesh, fibrous mesh, fibrous sleeve). Placing the wood shell with the respective core structure (i.e. fibrous construct, epoxy, flexible rod, joiner plug) into a first mold form having a first hybrid bat cavity and fixably mating with a second mold form having a second hybrid bat cavity. Inflating the bladder thereby applying a high pressure (i.e. 100 psi) radial force that causes a consequent embedding of the fiber sleeve in the central surface of the central core thus maximizing durability and minimizing potential delamination between the wood shell and sleeve during use. Here, the mold forms reinforce the radial wall of the wood shell preventing fracture as a result of the high internal bladder pressure. Applying one or more optional measures such as heat and UV radiation to accelerate quality bonding. Removing the hybrid baseball bat from the mold after the epoxy cures. Removing the expandable bladder after the epoxy cures. Fixing the end cap at the distal end of the central core with adhesives (if not done earlier). Then, forming a preferred external profile of the hybrid bat utilizing a wood bit in a standard or CNC lathe. Alternatively, the step of forming an external profile of the hybrid baseball bat may be completed as an earlier step in the hybrid baseball bat forming process.

The centrifugal force method begins with seating the wood shell with the respective core structure (i.e. fibrous construct, epoxy, flexible rod, joiner plug) into a rotary machine such as a lathe and spinning the wood shell with core structure at a high RPM to capture the effects of centrifugal force which propels mass (fibrous construct and epoxy-resin) in an outward direction embedding them into the central surface of the radial wall thereby maximizing durability and minimizing any prospect of delamination. As one example, the wood shell with core structure is spun for 5 minutes at approximately 1,800 rpms and then at 50 rpms until fully cured. The centrifugal method can also incorporate the step of applying one or more additional measures such as heat and UV light to accelerate curing. Then forming a preferred external profile of the hybrid bat utilizing a wood bit in standard or CNC lathe. Alternatively, the step forming an external profile of the hybrid baseball bat may be completed as an earlier step in the hybrid baseball bar forming process.

In one form, the central axis of the wood shell is substantially horizontal during spinning when using the centrifugal force method.

In one form, a combination of a centrifugal method and a bladder method may be used in the manufacture of a hybrid baseball bat.

In one form, and as would be recognized by one skilled in the art, various steps described herein for manufacture of a hybrid baseball bat can be rearranged in order where appropriate to obtain a similar result.

In one form, the fibrous sleeve is substantially tube shaped although formless in that its form can be readily manipulated by the application of minimal forces such as one or more of: centrifugal forces, forces from an expandable bladder, and forces from a elongate forming stick.

In one form, the fibrous sleeve is has a tapered diameter that is substantially 2 inches in diameter in a barrel portion and substantially 0.5 inches in diameter in a handle portion and tapering between these two diameters in a taper portion.

In one form, the fibrous sleeve has a bi-axial weave pattern.

In one form, the fibrous sleeve has a stiffness like a hollow rope.

In one form, the fibrous construct is formed by utilizing a spray head to spray a mix of high strength fibers and epoxy on to the central surface of the central core forming a high strength core structure that is embedded in the wood shell upon curing.

In one form, the thickness of the radial wall of the wood shell is about 0.3 inches in the barrel portion and about a minimum of 0.21 inches in the handle portion.

In one form, one or more of the radial surfaces, end cap, and proximal end of the hybrid bat are finished with one or more of stains and sealants preferably after completion of other hybrid baseball bat forming operations.

In one form, the hybrid baseball bat comprises a two-piece design comprising a handle segment and a barrel segment.

In one form, the hybrid baseball bat comprises a wood shell barrel portion joined to a composite molded handle having mechanical undercuts extending into the exterior surface of the molded handle from a distal end. The proximal end of the wood shell is positioned to overlap the mechanical undercuts and fixed with epoxy. In some forms, a fiber weave infiltrated with epoxy then overlaps the junction of the handle portion and barrel portion whereby the proximal end of the wood shell is secured by composites covering both the central surface and radial surface of the radial wall.

In one form, a method for a two-piece bat construction comprises the following steps. Obtaining a wood billet. Trimming the wood billet to a predetermined length. Forming a preferred external profile of the barrel of the wood shell utilizing a wood bit in standard or CNC lathe. Using a wood bit such as a gun drill bit and/or tapered drill bit to form the profiled central surface of the central core of the barrel. Roughening the central surface by one or more operations. If desired, using a fiber sleeve approach as previously described for formation on a central surface of the barrel core by using either the centrifugal method or the bladder method. Placing the barrel portion into a two-piece heated mold filled with precut carbon fiber layers on both sides of the narrowing end of the barrel such that the carbon fiber layer extends into the inside of the barrel of the bat to either develop the internal wall or to bond to the existing internal spun wall. Placing a predefined molding bladder into the negative cavity of the bat, partially in the barrel cavity and into the space in the mold for the molded bladder. Closing and securing the mold. Heating and filling the mold with compressed air consequently providing outward force to first bond the carbon fiber completely with the barrel and shape the handle.

In one form, the improved manufacturing methods described herein produce a wood shell having an enlarged central core that is consequently lighter in weight. Also consequently, material is then added back into the wood bat to reinforce highest stress areas and to meet regulatory weight specifications for certifying bodies such as BBCOR.

In one form, material added to the hybrid bat are adhesive materials reinforcing highest stress areas of the bat such as the handle portion and end cap.

In one form, the hybrid baseball bat design comprises an internally profiled wooden bat and one or more of: uniform radial wall thickness, variable radial wall thickness, tapered wall design, a variable thickness woven reinforcing internal structure to adhere to the internally profiled wooded bat, a continuous fiber weave extending through at least the handle portion and the barrel portion, and previously mentioned design features.

In one form, a hybrid baseball bat comprises a profiled central surface of varying diameters extending between the opposing ends of its wood shell.

In one form, the profiled central surface of varying diameters is absent of steps in the central surface.

In one form, the central core of a hybrid bat is reinforced using one or more of a fiber sleeve and fiber weave having a variable thickness.

In one form, the central core of a hybrid bat is reinforced using one or more of a fiber sleeve and fiber weave having a variable weave density.

In one form, the fiber sleeve and fiber weave are manufactured from a wide range of high strength materials.

In one form, a hybrid baseball bat comprises a profiled central surface of varying diameters extending between the opposing ends of its wood shell and further comprises a matching variable diameter composite fiber weave or fiber sleeve. This combination minimizes stress point concentrations.

In one form, a hybrid baseball bat is manufactured by forced volume method (FVD). This method comprises a two-part epoxy resin being dispersed into an enclosed portion of the central core of a bat's wood shell.

In one form, FVD comprises a moveable plunger assembly sized for sliding fit down a central core. A central core body enveloped by a fibrous sleeve is advanced into the central core towards a pool of epoxy resin that is forced into a space ‘F’ causing infiltration into the fibrous sleeve and non-fibrous pores until the core body is fully inserted. The core body can either be removed after the two-part epoxy resin fully cures or can be left in place and become part of the finished hybrid baseball bat.

In one form, a HPI (high pressure injection) method is utilized in the construction of a hybrid baseball ball. The open end of a hybrid baseball bat wood shell with central core is lined with a fibrous sleeve. An epoxy injector injects a 2-part epoxy (part ‘A’ and part ‘B’) under high pressure. A core body sized to create a space ‘F’ between the wood shell and the core body is utilized for seating the fibrous sleeve. Two-part epoxy resin is metered by injection time or stoke or discharge at an end vent which can be equipped with a vacuum. The two-part epoxy is injected into space ‘F’ causing infiltration into the fibrous construct and non-fibrous pores. The epoxy resin is left to cure and can be left in place and become part of the finished hybrid baseball bat.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, wherein cross-sectional views are from a plane extending through a central axis, and wherein:

FIG. 1 depicts a perspective view of a wood billet utilized in the manufacture of a hybrid baseball bat;

FIG. 1A depicts a perspective view of a wood billet along with the billet axis centerline and drilled pilot hole utilized in the manufacturing of a hybrid baseball bat;

FIG. 1B depicts a perspective view of a wood billet along with billet axis centerline and a axis bore extending along the billet axis centerline. The axis bore follows the billet centerline but with machine off-center tolerances. The axis bore is utilized in the manufacturing of a hybrid baseball bat;

FIG. 1C depicts a perspective view of a wood billet along with the billet axis centerline. An axis bore extends along the centerline and a tapered drill bit produces a drilled bore profile along the centerline;

FIG. 1D depicts a perspective view of a drilled wood billet along with the billet drilled axis centerline. This drilled wood billet is a standard utilized in the manufacturing of a hybrid baseball bat;

FIG. 1E depicts a perspective view of the drilled wood billet with a centerline plug seated in the handle core at the proximal end;

FIG. 2 depicts a perspective view of a hybrid baseball bat;

FIG. 3A depicts a cross-sectional view through a central axis of a wood shell of a hybrid baseball bat;

FIG. 3B depicts a cross-sectional view through a central axis of a wood shell plus the addition of a flex rod member of a hybrid baseball bat;

FIG. 4 depicts a side view of a tapered drill bit utilized for creating a profiled central core in a wood shell of a hybrid baseball bat;

FIG. 5 depicts a side cross-sectional view of a wood bit utilized to create a profiled central core in a wood shell of a hybrid baseball bat;

FIG. 6 depicts a side cross-sectional view of a wood shell of the hybrid baseball bat of FIG. 2;

FIG. 7 depicts a perspective cross-sectional view of the wood shell of the hybrid baseball bat of FIG. 2;

FIG. 8 depicts a perspective cross-sectional view of the hybrid baseball bat of FIG. 2;

FIG. 9 depicts a perspective view of the two-part epoxy layer of the hybrid baseball bat of FIG. 2;

FIG. 10 depicts a cross-sectional perspective view through a central axis of the two-part epoxy layer of the hybrid baseball bat of FIG. 2;

FIG. 11 depicts a perspective view of the fibrous construct of the hybrid baseball bat of FIG. 2;

FIG. 12 depicts a cross-sectional perspective view through a central axis of the fibrous construct of the hybrid baseball bat of FIG. 2;

FIG. 13 depicts a perspective view of an end cap used for enclosing the central core at the distal end of a hybrid baseball bat;

FIG. 14 depicts a side cross-sectional view of a hybrid baseball bat utilizing a flexible rod and joiner plug;

FIG. 15 depicts a side view of a flexible rod utilized in the hybrid baseball bat of FIG. 14;

FIG. 16 depicts a side view of a joiner plug utilized in the hybrid baseball bat of FIG. 14;

FIG. 17 depicts a side view of a fibrous sleeve and end cap utilized in a hybrid baseball bat;

FIG. 18A depicts a flow chart view of various methods of manufacturing a hybrid baseball bat;

FIG. 18B depicts a flow chart view of various methods of manufacturing a hybrid baseball bat;

FIG. 19 depicts a perspective cross-sectional view of a wood shell with roughened central surface;

FIG. 20 depicts a perspective cross-sectional view of a hybrid baseball bat during the course of manufacturing using a centrifugal force method;

FIG. 21 depicts a perspective cross-sectional view of a hybrid baseball bat during the course of manufacturing using a centrifugal force method;

FIG. 22 depicts a perspective cross-sectional view of a hybrid baseball bat during the course of manufacturing using a centrifugal force method;

FIG. 23 depicts a perspective cross-sectional view of a hybrid baseball bat during the course of manufacturing using a centrifugal force method;

FIG. 24 depicts a perspective view of a wood shell during the course of manufacturing;

FIG. 25 depicts a perspective view of the central core of a wood shell during the course of manufacturing;

FIG. 26 depicts a perspective view of the central core of a wood shell during the course of manufacturing;

FIG. 27 depicts a perspective view of a flattened fibrous sleeve;

FIG. 28 depicts a perspective view of a fibrous sleeve during expansion by a forming core blank;

FIG. 29 depicts a perspective view of the fibrous sleeve of FIG. 27-28 being introduced into the central core of a wood shell;

FIGS. 30 and 31 depicts a perspective view of a fibrous sleeve housed in a central core;

FIG. 32 depicts a perspective view of a hybrid baseball bat being spun at high speed during the course of manufacture using a centrifugal method;

FIG. 33 depicts a perspective view of the end cap depicted in FIG. 32 after trimming;

FIG. 34 depicts a perspective view of an inflatable bladder during the course of manufacture using a low pressure method;

FIG. 35 depicts a perspective cross-sectional view of a hybrid baseball bat during the course of manufacture using a low pressure method;

FIG. 36 depicts a perspective cross-sectional view of a hybrid baseball bat during the course of manufacture using a low pressure method;

FIG. 37 depicts a perspective view of a fibrous sleeve and inflatable bladder during the course of manufacture using a low pressure method;

FIG. 38 depicts a perspective cross-sectional view of a hybrid baseball bat during the course of manufacture using a low pressure method;

FIG. 39 depicts a perspective cross-sectional view of a hybrid baseball bat during the course of manufacture using a low pressure method;

FIG. 40 depicts a perspective cross-sectional view of a hybrid baseball bat during the course of manufacture using a low pressure method;

FIG. 41 depicts a perspective cross-sectional view of a hybrid baseball bat during the course of manufacture using a high-pressure method;

FIG. 42 depicts a perspective cross-sectional view of a hybrid baseball bat during the course of manufacture using a high-pressure method;

FIG. 43 depicts a perspective view of an expandable bladder seated in a fibrous sleeve during the course of manufacture of a hybrid baseball bat using a high-pressure method;

FIG. 44 depicts a perspective cross-sectional view of a hybrid baseball bat during the course of manufacture using a high-pressure method;

FIG. 45 depicts a perspective view of a hybrid baseball bat seated in a first mold form during the course of manufacture using a high-pressure method;

FIG. 46 depicts a perspective cross-sectional view of a hybrid baseball bat seated between a first and second mold form during the course of manufacture using a high-pressure method;

FIG. 47 depicts a perspective cross-sectional view of a hybrid baseball bat during the course of manufacture using a high-pressure method;

FIG. 48 depicts a perspective cross-sectional view of a hybrid baseball bat during the course of manufacture using a high-pressure method;

FIG. 49 depicts a perspective cross-sectional view of a hybrid baseball bat during the course of manufacture using a high-pressure method.

FIG. 50A depicts a cross-sectional view of two-part epoxy resin infiltrating a fibrous construct by forced volume displacement;

FIG. 50B depicts a cross-sectional view of two-part epoxy resin infiltrating a fibrous construct by forced volume displacement;

FIG. 50C depicts a cross-sectional view of two-part epoxy resin infiltrating a fibrous construct by forced volume displacement;

FIG. 51A depicts a cross-sectional view of two-part epoxy resin being pre-mixed and high pressure injected into the fibrous construct cavity to infiltrate the fibrous construct in the direction of the wood billet central core;

FIG. 51B depicts a cross-sectional view of two-part epoxy resin being pre-mixed and high pressure injected into the fibrous construct cavity to infiltrate the fibrous construct in the direction of the wood billet central core;

FIG. 51C depicts a cross-sectional view of two-part epoxy resin being pre-mixed and high pressure injected into the fibrous construct cavity to infiltrate the fibrous construct in the direction of the wood billet central core;

FIG. 52 depicts a perspective view of a removable core body (fibrous construct not shown) and flex rod;

FIG. 53 depicts a perspective view of a removable core body (fibrous construct not shown) being removed from a wood billet leaving the flex rod inserted in the handle portion of the wood billet;

FIG. 54 depicts a perspective view of FIG. 53 showing the fibrous construct plus flex rod secure on the central surface by two-part epoxy resin. The central core assembly (flexible rod and core body) is highlighted within the shaded wood billet;

FIG. 55 depicts a perspective view showing the fibrous construct plus flex rod secure on the central surface by two-part epoxy resin and the distal end cap being installed. The central core assembly is highlighted within the shaded wood billet;

FIG. 56 depicts a perspective view showing the fibrous construct plus flex rod secure on the central surface by two-part epoxy resin and the distal end cap installed. The central core assembly is shown within the formed baseball bat. The wood billet is shown shaded;

FIG. 57 depicts a perspective view of a removable core body (fibrous construct not show), flex rod and vibration dampening plug;

FIG. 58 depicts a perspective view of a removable core body (fibrous construct not show) being removed from the billet central and leaving the flex rod and vibration dampening plug inserted into the transition and handle portion of the wood billet;

FIG. 59 depicts a perspective view of FIG. 58 showing the fibrous construct plus flex rod and vibration dampening plug secure on the central surface by two-part epoxy resin. The central core assembly is highlighted within the shaded wood billet;

FIG. 60 depicts a perspective view showing the fibrous construct plus flex rod and vibration dampening plug secure on the central surface by two-part epoxy resin and the distal end cap being installed;

FIG. 61 depicts a perspective view showing the fibrous construct plus flex rod and vibration dampening plug secure on the central surface by two-part epoxy resin and the distal end cap installed. The central core assembly is shown within the formed baseball bat. The wood billet is shown shaded;

FIG. 62 depicts a perspective view of a vibration dampening foam core body and flex rod. Fibrous construct not show;

FIG. 63 depicts a perspective view of a vibration dampening foam core body and flex rod. Fibrous construct is shown;

FIG. 64 depicts a perspective view of FIG. 63 showing the fibrous construct plus flex rod and vibration dampening foam secure on the central surface by two-part epoxy resin. The central core assembly is highlighted within the shaded wood billet;

FIG. 65 depicts a perspective view showing the fibrous construct plus flex rod and vibration dampening plug and vibration dampening foam secured on the central surface by two-part epoxy resin and the distal end cap being installed. The central core assembly is highlighted within the shaded wood billet;

FIG. 66 depicts a perspective view showing the fibrous construct plus flex rod and vibration dampening plug and vibration dampening foam secure on the central surface by two-part epoxy resin and the distal end cap installed. The central core assembly is shown within the formed baseball bat. The wood billet is shown shaded;

FIG. 67 depicts a perspective view of a 3D printed core body and flex rod with fibrous construct absent;

FIG. 68 depicts a perspective view of a 3D printed core body and flex rod. Fibrous construct sleeve is shown;

FIG. 69 depicts a perspective view of a 3D printed core body and flex rod with the fibrous construct sleeve shown. The central core assembly is highlighted within the shaded wood billet;

FIG. 70 depicts a perspective view of a 3D printed core body, flex rod and vibration dampening plug with the fibrous construct sleeve shown. The central core assembly is highlighted within the shaded wood billet;

FIG. 71 depicts a perspective view showing the fibrous construct plus flex rod and vibration dampening plug and 3D printed core body secure on the central surface by two-part epoxy resin and the distal end cap installed. The central core assembly is shown within the formed baseball bat. The wood billet is shown shaded;

FIG. 72 depicts a perspective view of injection molded half shell core body and flex rod. Fibrous construct not shown;

FIG. 73 depicts a perspective view of injection molded half shell core body and flex rod. Fibrous construct sleeve is shown;

FIG. 74 depicts a perspective view of injection molded half shell core body and flex rod with the fibrous construct sleeve shown. The central core assembly is highlighted within the shaded wood billet;

FIG. 75 depicts a perspective view of injection molded half shell core body, flex rod and vibration dampening plug with the fibrous construct sleeve shown. The central core assembly is highlighted within the shaded wood billet;

FIG. 76 depicts a perspective view showing the fibrous construct plus flex rod and vibration dampening plug and injection molded half shell secure on the central surface by two-part epoxy resin and the distal end cap installed. The central core assembly is shown within the formed baseball bat. The wood billet is shown shaded;

FIG. 77 depicts a perspective view of the wood billet with its drilled small diameter central axis core and proximal end wood plug;

FIG. 78 depicts a perspective view of the wood billet with its drilled small diameter central axis core with additional flex rod or high strength tether. The fibrous construct is shown on the entire length of the flex rod or high strength tether;

FIG. 79 depicts a perspective view of the wood billet with its drilled small diameter central axis core with additional flex rod or high strength tether. The fibrous construct is shown on the enter length of the flex rod or high strength tether. The central core assembly is highlighted within the shaded wood billet shown within the formed baseball bat. The wood billet is shown shaded;

FIG. 80 depicts a flow chart view of various methods of manufacturing a hybrid baseball bat;

FIG. 81 depicts manufacturing methods to cause the two-part epoxy assembly and fibrous construct to bond to the central cavity wall;

FIG. 82 depicts a flow chart view of the final steps to finish the baseball bat;

FIG. 83 depicts a side view of a wood billet and a progression of cross-sectional views of the billet following a series of machine operations before the outer surface of the billet is machined;

FIG. 84 depicts a perspective view of a proximal plug in detail A wherein the proximal plug is seated in the handle core of the billet as further depicted in the lower cross-sectional views;

FIG. 85 depicts a perspective view of formless fiberous sleeve;

FIG. 86 depicts views of a dowel (forming stick) inserted into the fiberous sleeve depicted in FIG. 85;

FIG. 87 depicts a perspective view of a dowel and a core body seated in the interior of the fiberous sleeve;

FIG. 88 depicts a series of cross-sectional and perspective views of steps in the manufacture of a baseball bat using a removable profiled core body;

FIG. 89 depicts a series of cross-sectional and perspective views of steps in the manufacture of a baseball bat using a removable core body to deposit a profiled vibration dampening plug;

FIG. 90 depicts a series of cross-sectional and perspective views of steps in the manufacture of a baseball bat using a vibration dampening foam core body;

FIG. 91 depicts a series of cross-sectional and perspective views of steps in the manufacture of a baseball bat using a vibration dampening foam core body with profiled vibration dampening plug;

FIG. 92 depicts a series of cross-sectional and perspective views of steps in the manufacture of a baseball bat using a hollow thermoplastic core body;

FIG. 93 depicts a series of cross-sectional and perspective views of steps in the manufacture of a baseball bat using a hollow thermoplastic core body with profiled vibration dampening plug;

FIG. 94 depicts a series of cross-sectional and perspective views of steps in the manufacture of a baseball bat using a hollow 2-half shell thermoplastic core body;

FIG. 95 depicts a series of cross-sectional and perspective views of steps in the manufacture of a baseball bat using a hollow 2-half shell thermoplastic core body with profiled vibration dampening plug;

FIG. 96 depicts cross-sectional and perspective views of steps in the manufacture of a baseball bat using a tethered core body;

FIG. 97 depicts cross-sectional and perspective views of a fully tethered bat;

FIG. 98 depicts cross-sectional views of a billet with fiberous core seated therein.

### DETAILED DESCRIPTION OF SELECTED EMBODIMENTS OF THE INVENTION

Select embodiments of the invention will now be described with reference to the Figures. Like numerals indicate like or corresponding elements throughout the several views and wherein various embodiments are separated by letters (i.e. 100, 100B, 100C). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes, or which is essential to practicing the invention described herein.

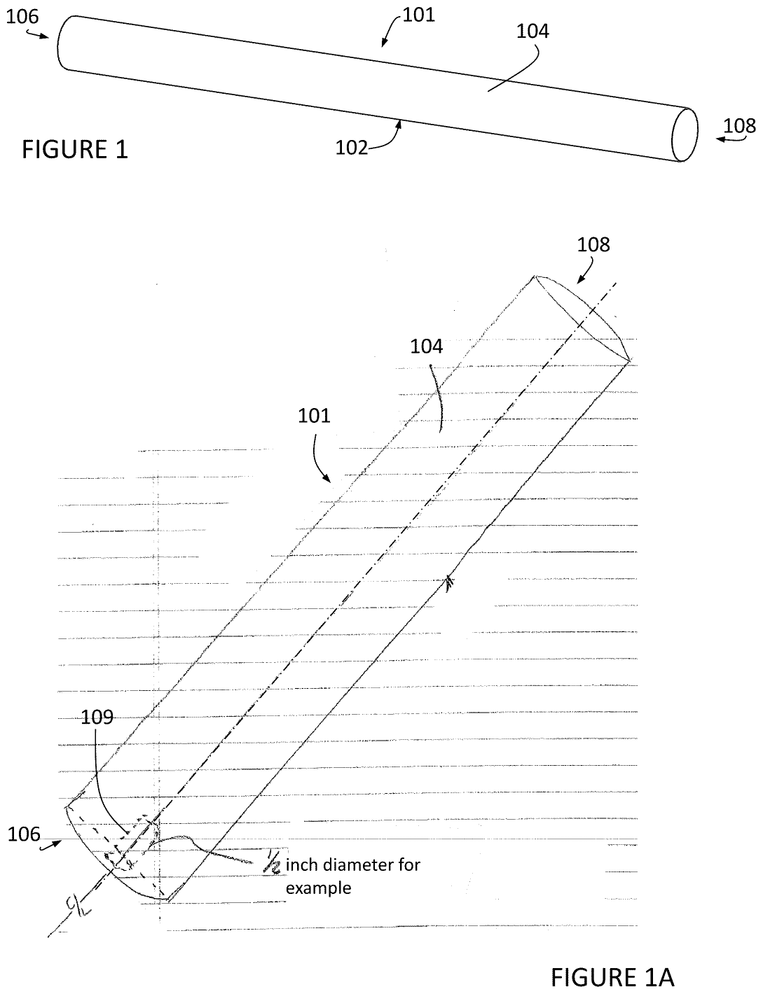

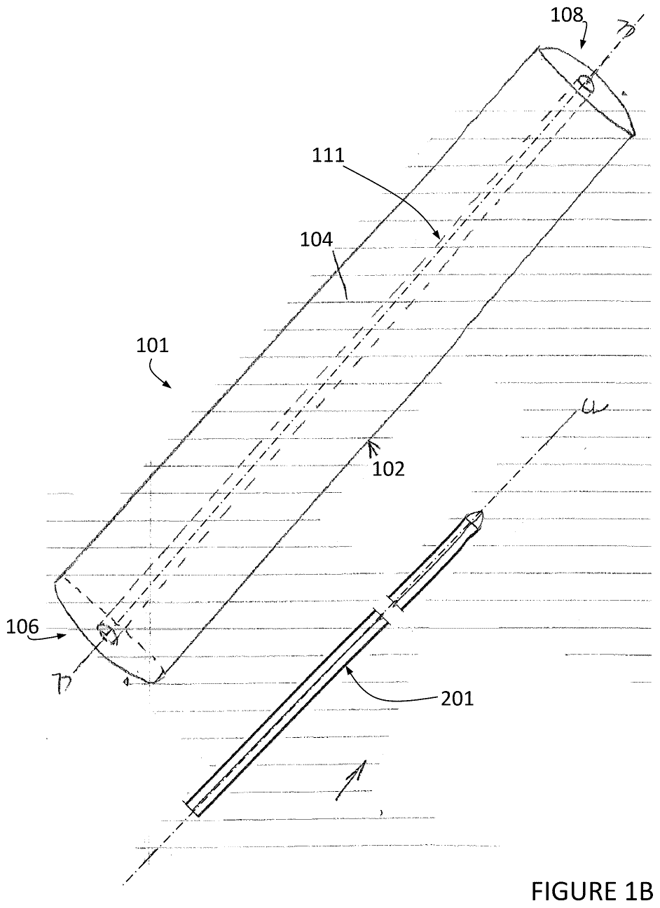

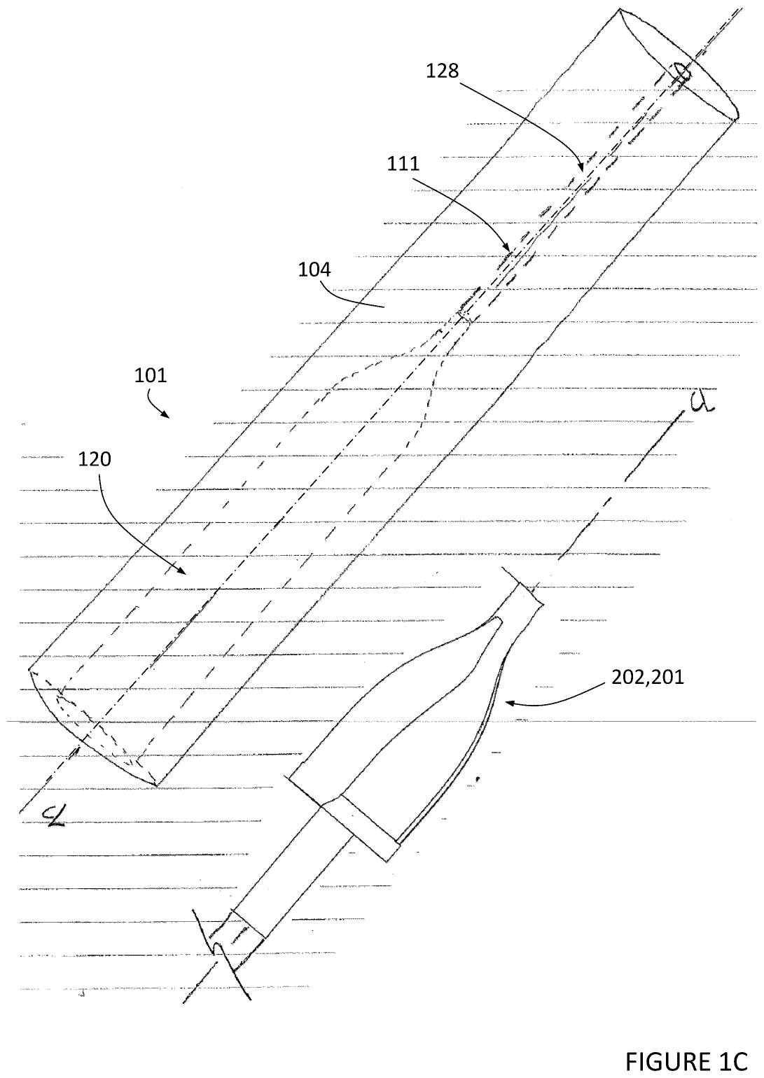

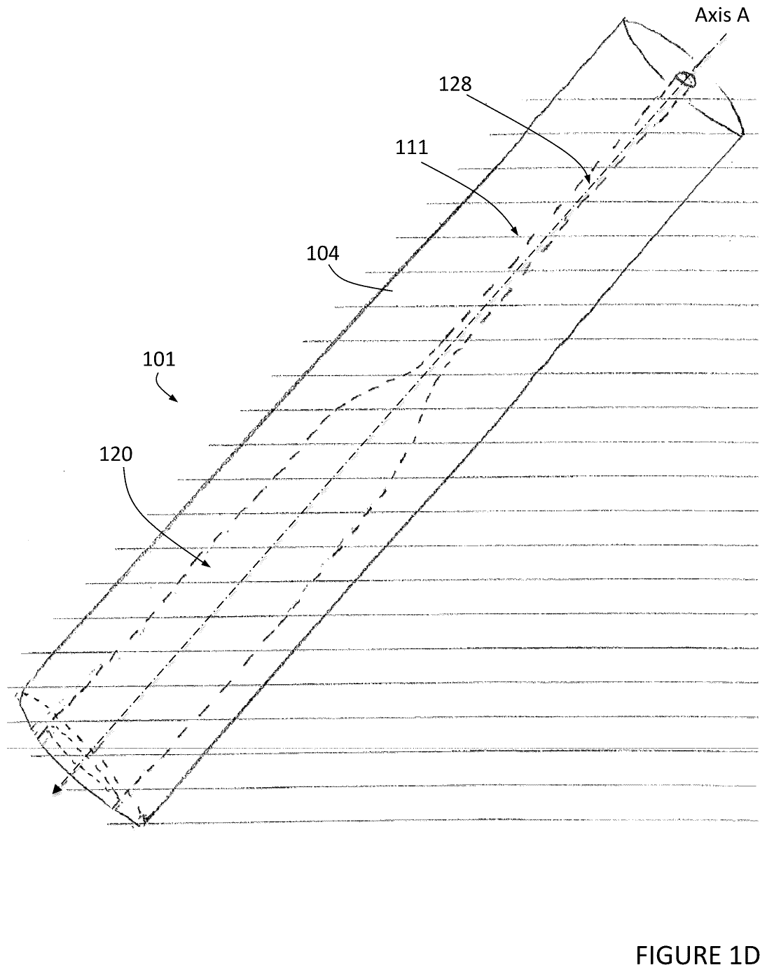

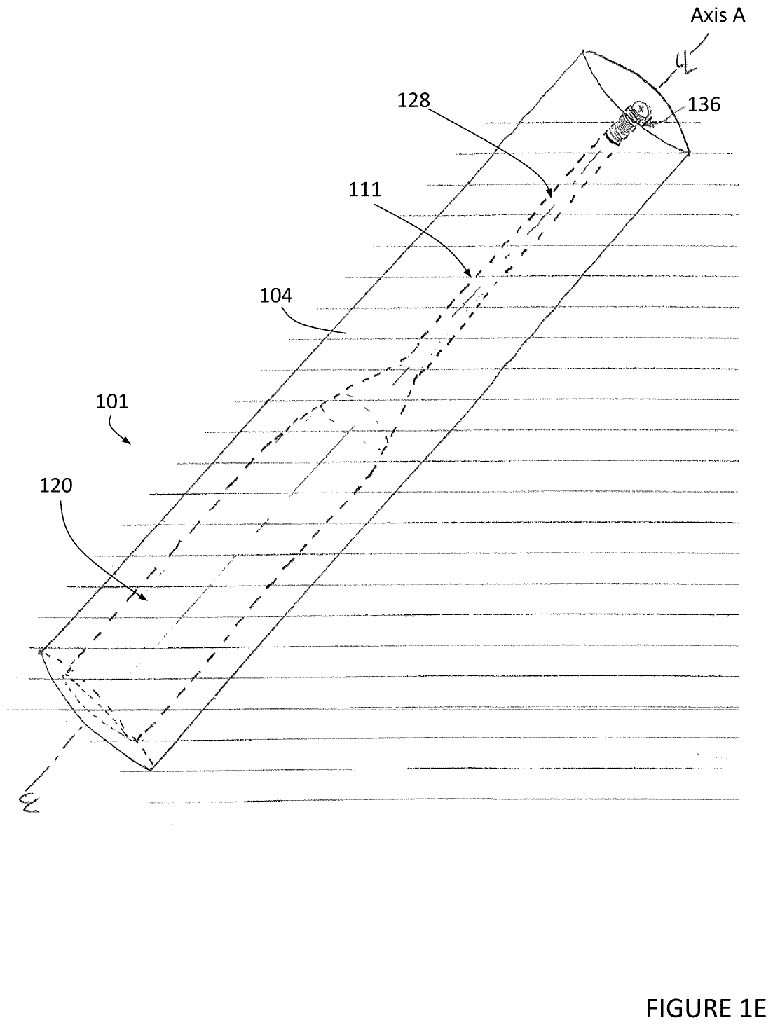

FIG. 1 illustrates a wood billet 101 which contains a proximal end 105 and a distal end 107 with an outer surface 104 of billet body 102. FIG. 1A illustrates one embodiment of a wood billet 101 with a first machining step to add a true on-center pilot hole in the distal end of the wood billet. This pilot hole is utilized to assure long central axis drills begin at the true on-center. FIG. 1B depicts one example of a long drill (i.e. gun drill bit 201) that can be used to bore the central axis small hole. FIG. 1C depicts a larger diameter hole bored with a tapered drill bit 202 to a predetermined position providing a smooth transition between a barrel core 120 and a handle core 128 defined by central surface 116. FIG. 1D illustrates the complete drilled billet with the boring on the wood billet central axis A. FIG. 1E depicts the drilled wood billet 101 of FIG. 1D with the addition of proximal plug 136 seated at the proximal end of the wood billet. Proximal plug typically has a cylindrical body sized for fit with in handle core 128.

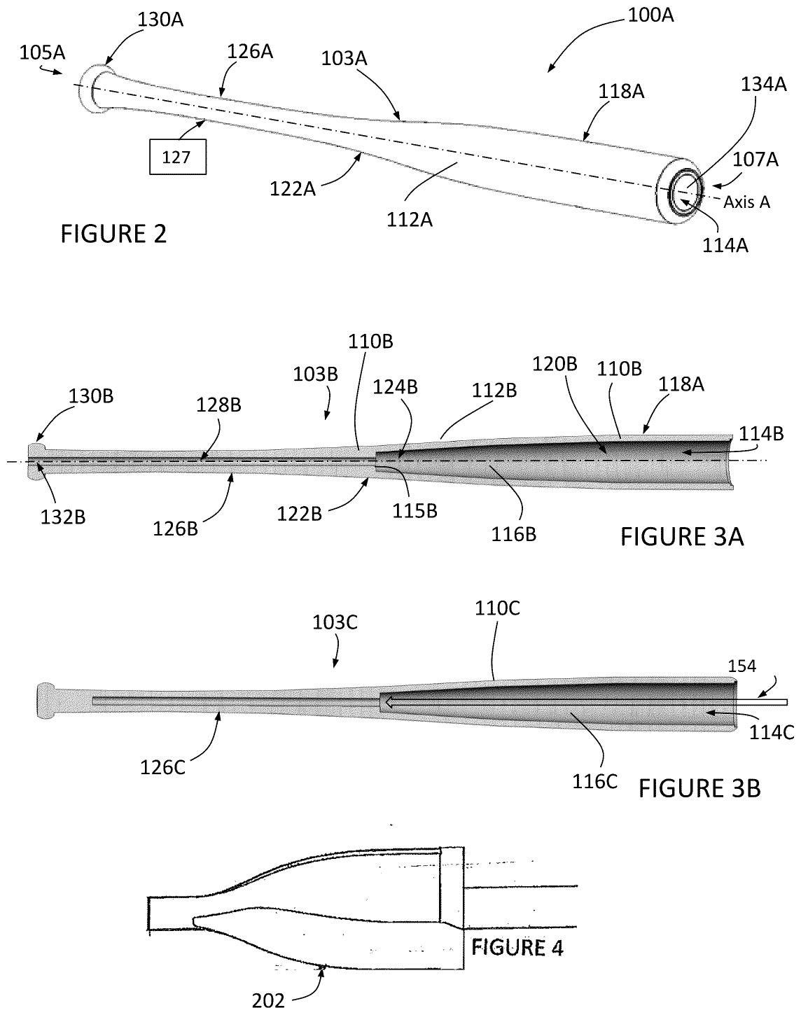

FIG. 2 illustrates one embodiment of the article of invention before placement of optional grip 127 and application of final wood sealants. Hybrid baseball bat 100A is illustrated in an otherwise finished configuration comprising a wood shell 103A, a radial surface 112A on the wood shell, an enlarged knob portion 130A at a proximal end 105A, an enlarged barrel portion 118A at a distal end 107A, and a taper portion 122A intermediate the handle portion 126A and barrel portion 118A. An end cap 134A seals the distal end (also FIG. 13). A core structure 140A (FIG. 8) housed in a central core 114A reinforces the wood shell 103A. The hybrid baseball bat comprises a variety of materials including but not limited to wood such as maple and birch utilized in the wood shell 103A. The hybrid baseball bat 100A can comprise a variety of materials including but not limited to composites such as carbon fiber, resin, fiberglass, and Kevlar. In this embodiment, the core structure 140A comprises a fiberous construct 141A such as a carbon fiber sleeve with a cured two-part epoxy.

The central core 114B in some embodiments extends the entire length of a wood shell 103B from a proximal end to a distal end as illustrated in FIG. 3A whereas in other embodiments, the central core 114C only extends partially into the handle portion 126C as illustrated in FIG. 3B or alternatively only into the barrel portion and taper portion. The barrel portion, taper portion, handle portion and knob portions each have a respective core portion in the central core 114B and are thus termed a barrel core 120B, a taper core 124B, a handle core 128B, and a knob core 132B. Central core 114B comprises a profiled central surface 116B defining central core 114B. The profiled central surface 116B and radial surface 112B define a radial wall 110B extending therebetween and forming wood shell 103B.

In preferred embodiments, the hybrid baseball bats disclosed are manufactured from a wood billet 101 that is substantially cylinder shaped as illustrated in FIG. 1. Here, the wood billet is greater than 34 inches long with a diameter greater than 2.625 inches and preferably wood billet 101 is approximately 37 inches×2.8 inches. The wood billet 101 comprises a billet body 102 with an outer surface 104 and has a first billet end 106 and a second billet end 108. The outer surface 104 of the billet body is machined to create a profiled radial surface recognizable to baseball bats with a maximum diameter along the barrel portion and a minimum diameter in the handle portion.

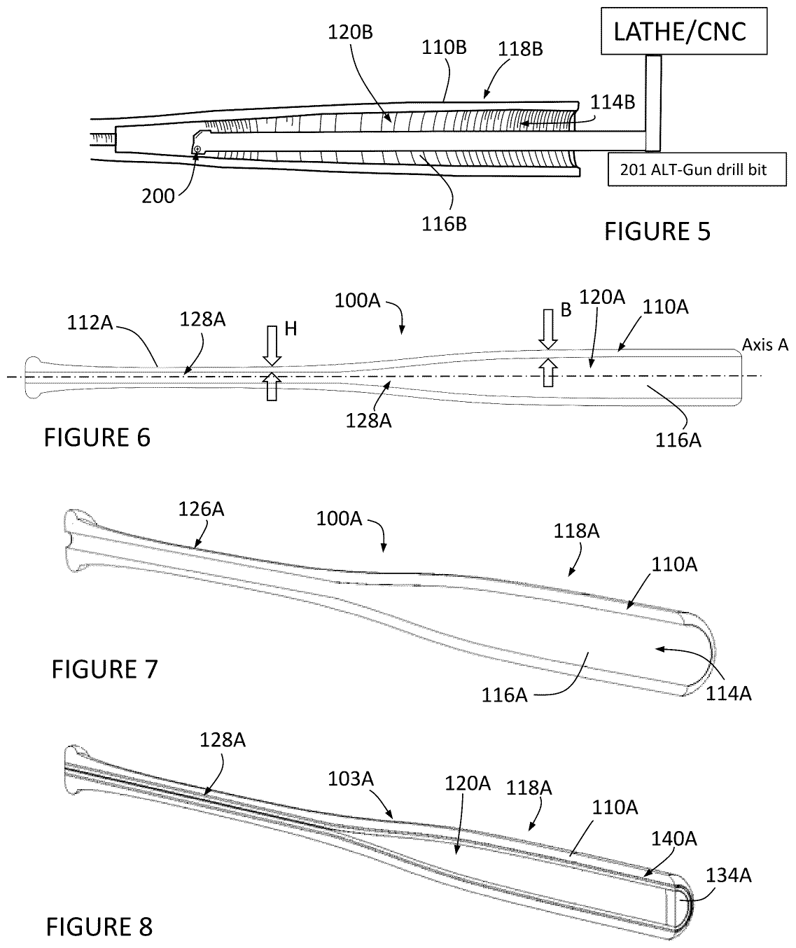

In some embodiments, the central core of the hybrid baseball bat is created by drilling using one or more drill bits such as the tapered drill bit 202 illustrated in FIG. 4. Note that the outer cutting surface of the tapered drill bit varies in diameter forming a profiled central surface 116B. Radial wall 110B remains between the outer profiled radial surface 112B and central surface 116B. Alternatively, the central core 114B is created by one or more wood bits 200 that are driven by one or more of a lathe and CNC machine as illustrated in FIG. 5. In other embodiments, the central core is created by gun drill wood bits 201 advanced in a gun drilling machine. Air pressure can be introduced during gun drilling of the central core to remove wood chips and reduce heat buildup during cutting operations. Wood bits 200 utilized to create the central core include but are not limited to one or more of normal/standard, Forstner, gun drill, and CNC cutting bit. The central core is describable in profile as but not limited to: uniform, variable, concave, and negative through any portion of the central core.

In some embodiments such as illustrated in FIG. 6-8, central surface 116A and radial surface 112A are profiled such that each surface of the wood shell is continuous and absent of obvious steps except for at the junction of the knob portion and handle portion on the radial surface. Comparatively, note step 115B in FIG. 3A illustrating an interrupted central surface. In this embodiment (FIG. 6), the radial wall thickness in the wood shell is substantially uniform with slight variation between the radial wall thickness in the barrel portion (B) which measures about. 3 inches and the radial wall thickness in the handle portion (H) which measures about 0.21 inches. In other embodiments, the central surface is profiled to provide a consequent variable radial wall thickness, tapered wall design.

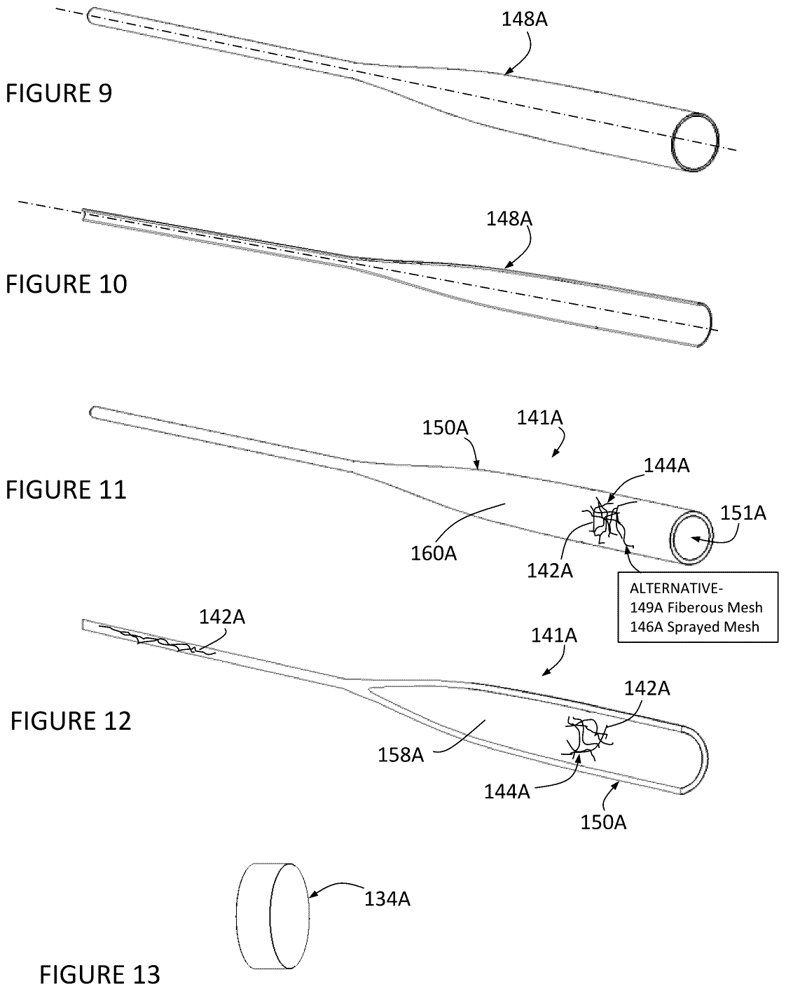

FIGS. 9-12 illustrates various layers of a core structure of the hybrid baseball bat 100A illustrated in FIGS. 2 and 8. FIGS. 9-10 represents the two-part epoxy 148A layer which in an un-finished configuration is uncured and infiltrates fibrous construct 141A and bonds to the central surface 116A of the radial wall 110A of wood shell 103A before curing in place in a finished configuration. The fibrous construct 141A comprises a plurality of high strength fibers 142A in the form of a weave 144A which can have general shape manipulated for use in the central core. In preferred embodiments for example, the fibrous construct 141A is in the form of a fibrous sleeve 150A having an outer face 160A and an inner face 158A defining an internal chamber 151A. The fibrous sleeve can have a bi-axial weave pattern. The high strength fibers 142A used in the hybrid baseball bat 100A are arranged and can be varied in weave type, weave direction, weave thread count (density), weave thickness, and weave layers to produce a desired hybrid bat performance characteristic such as bat weight, bat center of gravity, bat stiffness, and bat ductility. Further each of these weave parameters can be varied depending on the location. For example only, the weave thickness may be greater in the barrel portion as compared to the handle portion. The hybrid bat illustrated in FIG. 8 comprises a much larger diameter barrel core 120A compared to the handle core 128A. The corresponding fibrous sleeve used in this bat is substantially 2 inches in diameter in a barrel portion and substantially 0.5 inches in a handle portion of the sleeve and tapering between these two diameters in a taper portion 122A.

Fibrous construct 141A can be manufactured from a variety of high strength fibers not limited to carbon fiber and Kevlar. In alternative forms, the fibrous construct 141A is in the form of a fibrous mesh 149A such as a sprayed mesh 146A formed by utilizing a spray head to spray a mix of high strength fibers and epoxy mix on to the central surface of the central core forming a high strength core structure that is embedded in the wood shell upon curing. Other variations include varying types of two-part epoxy 148A used in the hybrid baseball bat 100A to produce a desired hybrid bat performance characteristic such as bat weight, bat center of gravity, bat stiffness, and bat ductility.

A weave 144A formed from high strength fibers 142A is varied in diameter and shape through exertion of one or more of internal and external forces during the hybrid baseball bat manufacturing process. For example, fibrous sleeve 150A, with an initial stiffness like a hollow rope, can begin ‘formless’ or otherwise in the shape of a flattened tube in an unfinished configuration before opened and expanded to its final cylindrical tube form inside the central core 114A of the hybrid baseball bat 100A in a finished configuration. The aforementioned forces cause the weave 144A to be embedded in wood shell 103A of the hybrid bat by an outward radial force directed from a central axis (axis A). These outward radial forces can be due for example from one or more of: a forming stick 162 pushed down the internal chamber 151A, inflation of an expandable bladder inside the central chamber, and centrifugal force as a consequence of high speed rotation of the wood shell along the central axis. Forming stick 162 in preferred forms is an elongate cylindrical bar made of wood or plastic. Other methods include forced positive displacement, and high-pressure injection with vacuum assist. These methods will be explained in more detail later in this document.

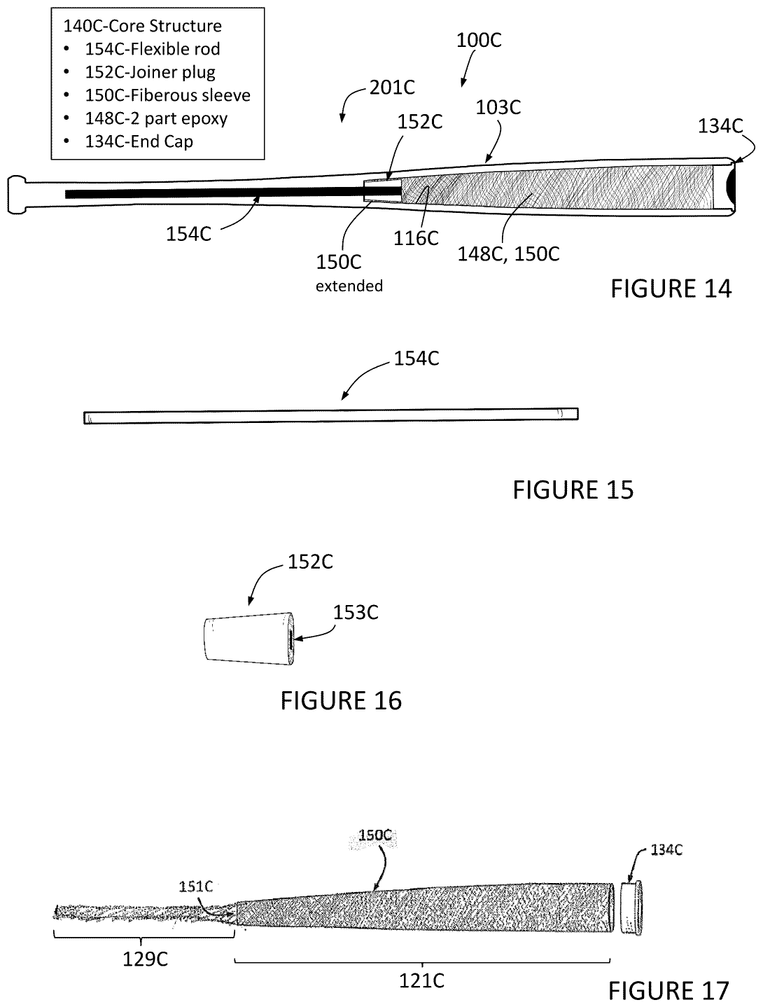

FIG. 14 illustrates one embodiment of a hybrid baseball bat with internal core structure 140C. FIGS. 15-16 depicts individual parts of the bat. The core structure is operable to add strength and support to the wood shell 103C of the hybrid baseball bat. The core structure 140C comprises a flexible rod 154C with a distal end of the flexible rod housed in the plug aperture 153C of a joiner plug 152C. FIG. 17 depicts one form of a core structure comprising a continuous fiberous sleeve having a narrower handle sleeve portion 129C extending from a larger diameter barrel sleeve portion 121C. In the FIG. 14 embodiment, a joiner plug 152C resides in the proximal end of the internal chamber 151C of fibrous sleeve 150C which is infiltrated with two-part epoxy 148C. The core structure (flexible rod, joiner plug, fibrous sleeve infiltrated with epoxy) is housed in the central core 114C of wood shell 103C (FIG. 3B). This configuration maximizes handle portion strength, minimizes pre-mature handle fracture, provides increased handle portion flexibility, and minimizes negative handle vibrations.

Joiner plug 152C has an outer surface sized and shaped for seating at the proximal end of barrel core 120C. In this embodiment, joiner plug 152C is substantially conical shaped whereas plug aperture 153C is a cylindrical through hole extending through the central axis of the plug.

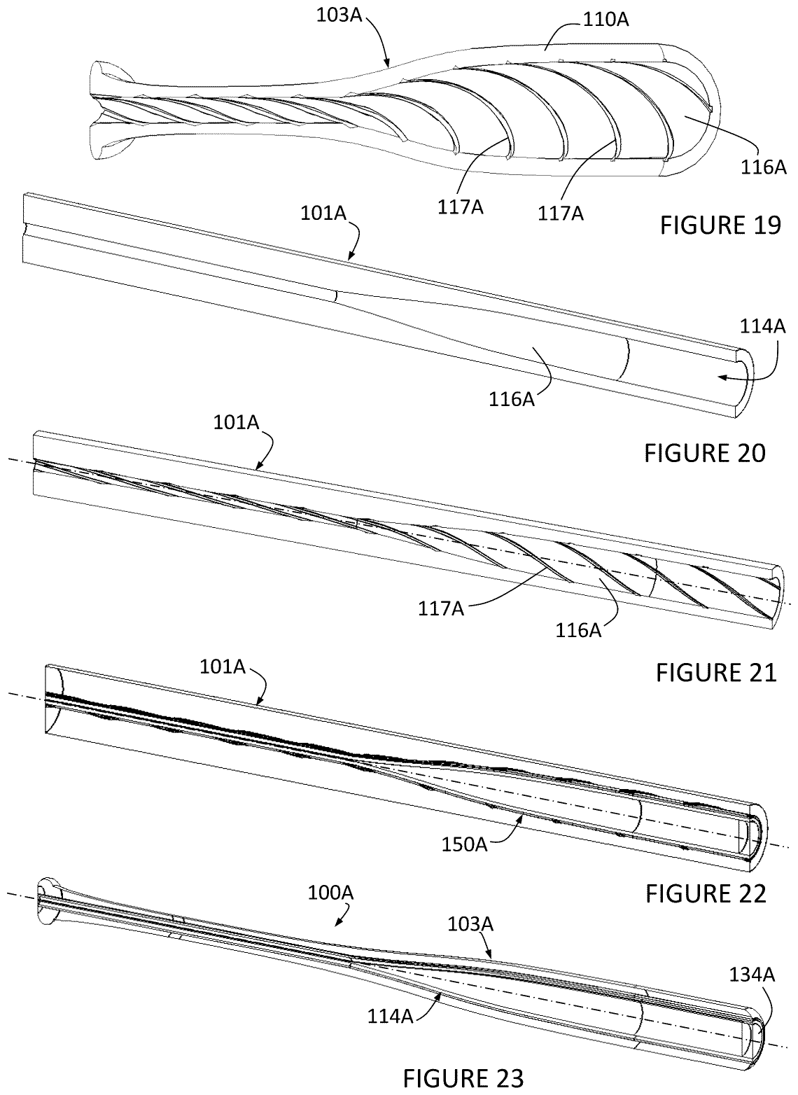

FIG. 21 depicts a wood billet 101A in cross-section with internal machining. FIG. 19 depicts a wood shell 103A shown in cross-section after machining the inner and outer surfaces of the wood billet to become a wood shell 103A. In some embodiments, grove markings 117A (roughening) are etched on the inner surface of the wood shell whereas in other embodiments, such as depicted in FIG. 20, a smooth central surface 116A can be used. FIG. 22 provides a cross-section of a wood billet 101A of a hybrid baseball bat whereas FIG. 23 depicts a cross-sectional view of a hybrid baseball bat 100A after machining of the outer surface of the billet. Both depict a fibrous construct 141A positioned in central core 114A (with or without a core body 164).

In a finished configuration, a portion of fibrous sleeve 150C is sandwiched between central surface 116C and the outer surface of the joiner plug 152C as illustrated in FIG. 14.

As noted in earlier embodiments, core structure 140C comprises a formless fiberous sleeve 150C in a pre-finished configuration that is flexible and can expand and contract as necessary to fit the profile of the central core as defined by the profiled central surface 116C. Optionally, a portion of central surface 116C is roughened by one or more operations including but not limited to scouring, grooving, sanding, rifling, and other processes known in the art to ensure the tightest and strongest fit and adhesion to the bat's internal walls. Roughening 117A by rifling of a central surface is illustrated in FIG. 19.

As noted in FIGS. 3A, 3B, and 6, the wood shell incorporates a profiled central surface 116 on the radial wall 110 as a base on which the fiber sleeve can adhere. The profiled central surface of the radial wall can be formed by a variety of operations. For example, a tapered drill bit 202 (i.e. FIG. 4) introduced on a lathe may be used to form central core 114. The outer face of the tapered drill bit comprises the complementing central surface contour to create the barrel core. Alternatively, the profiled central surface 116B of the radial wall 110B is formed by a wood bit 200 driven by a CNC machine programmed to create the tapered profile of the central surface as illustrated in FIG. 5. The CNC lathe is used to shape the central surface of the radial wall based on a programmed profile. This method maximizes the barrel cavity while minimizing stress concentration points in the radial wall. In addition, a drill bit extension can be utilized along the same axis to drill partially into or through the handle portion of the hybrid baseball bat thereby creating a space to refill with a more flexible material than wood. This flexibility minimizes negative vibrations felt at any point of contact of the baseball on the bat and minimizes handle breakage.

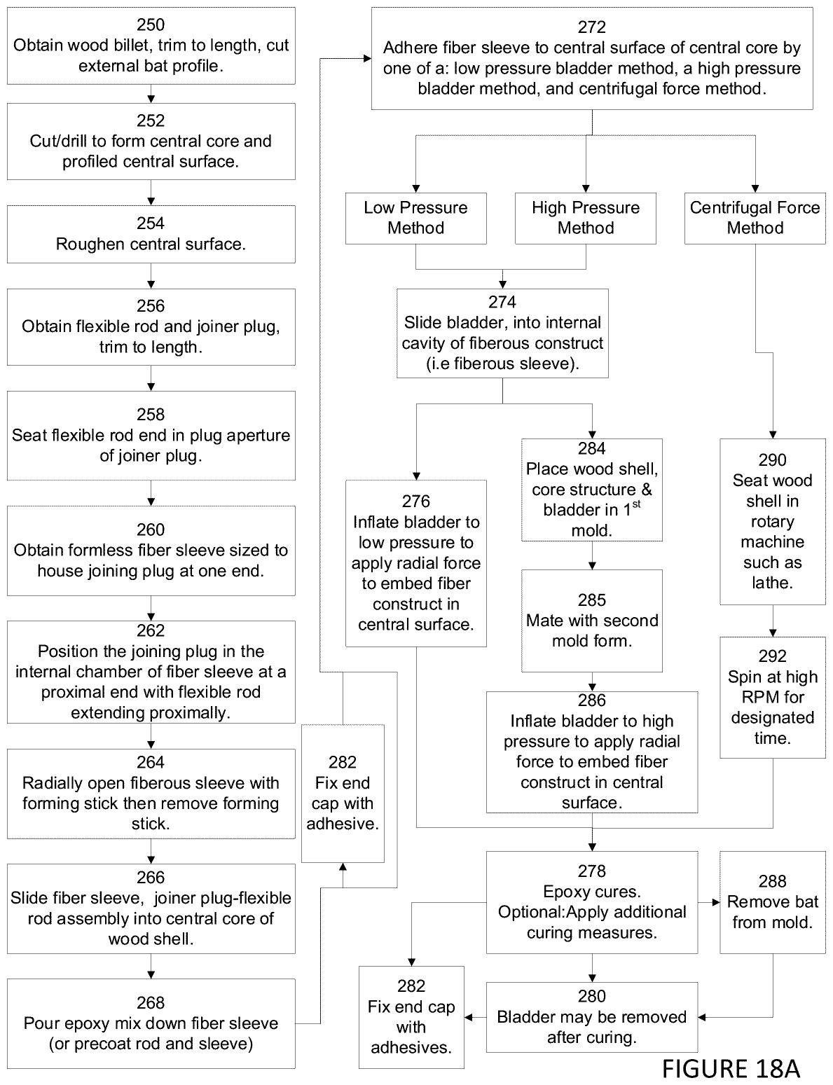

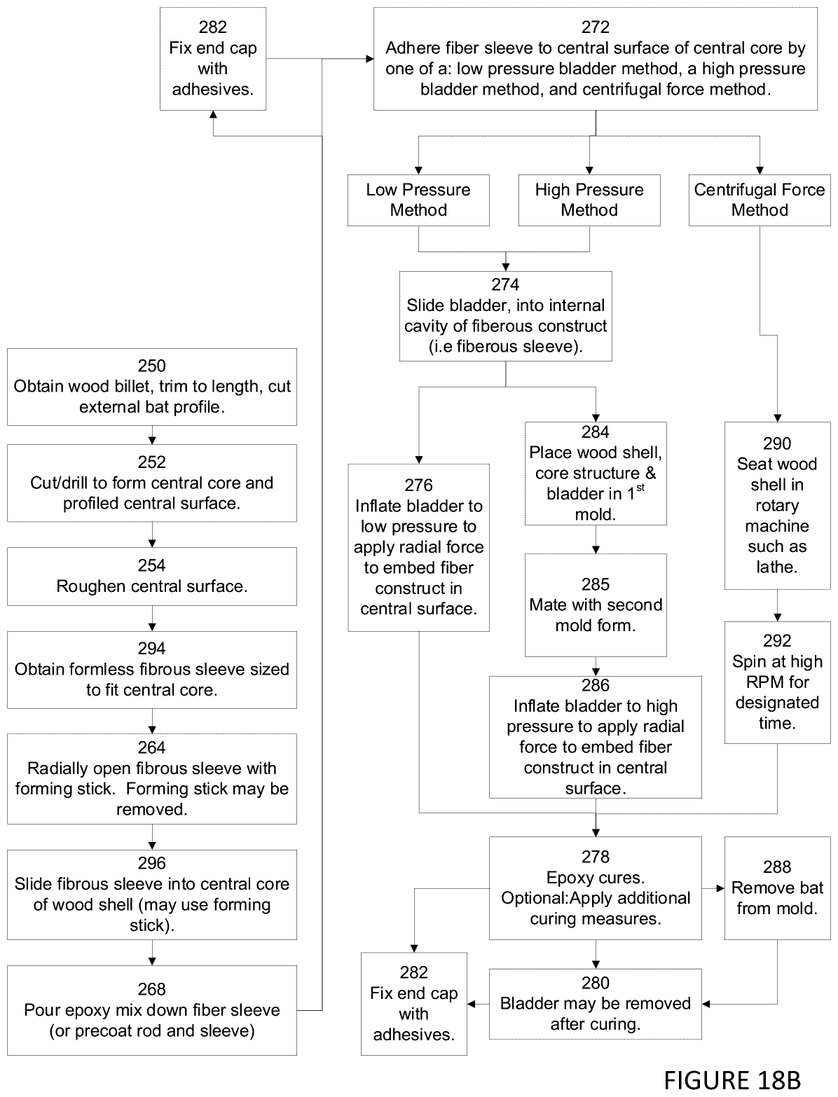

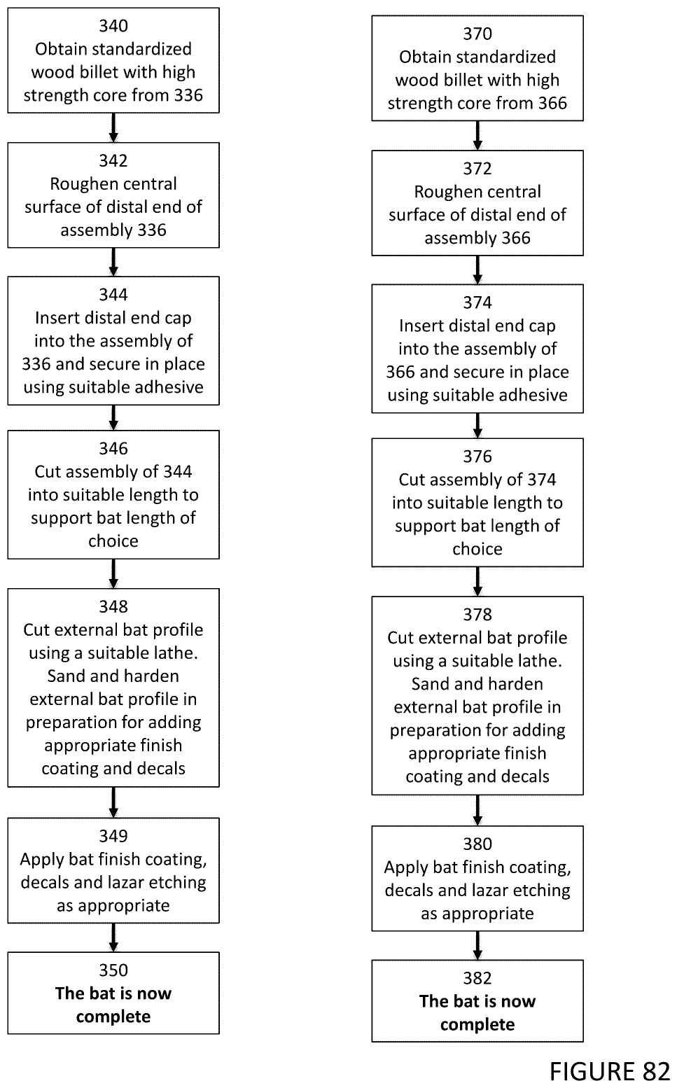

In one form, a method of constructing a hybrid baseball bat 100C (FIG. 14) comprises the following steps (FIG. 18A) with each step listed in numeric form (XXX). Obtaining a wood billet sufficient in length to make a one piece full length wood shell (i.e. knob to end cap). Trimming the wood billet to a predetermined length and cutting the external bat profile into the radial surface (250) (cutting profile can be delayed until the end, i.e. FIG. 82). Forming the profiled central surface of the central core using a machine operation such as one or more of but not limited to: gun drilling, wood bit boring, and drilling with tapered drill bit (252). Optionally, roughening the central surface by one or more operations such as rifling (254). Obtaining a flexible rod of a predetermined length and sized for housing in the handle core. Obtaining a joiner plug of a predetermined size for fit into the proximal end of the barrel core of the hybrid baseball bat (256), Fixing the joiner plug to one end of the flexible rod by inserting the flexible rod end into the plug aperture of the joiner plug (258), Obtaining a formless fibrous sleeve sized to house the joiner plug therein at one end (260) and positioning the joiner plug in the fiber sleeve accordingly with the remaining flexible rod extending proximally away from the fibrous sleeve. Sliding the fibrous sleeve over the joining plug and attaching the fiber sleeve on an edge at the proximal end of the joining plug, Inserting the fibrous sleeve, joiner plug, and flexible rod assembly into the central core from the distal end (262). If necessary, radially opening the fibrous sleeve using a forming stick inserted down its internal chamber to approximate the outer face with the central surface of the wood shell, Removing the forming stick (264). Sliding the fiber sleeve, joiner plug and flexible rod assembly into central core of the wood shell. (266). Pouring an epoxy mix down the central core (alternatively, the fibrous sleeve and flexible rod may be pre-wetted with epoxy) (268). Fixing the end cap at the distal end of the central core with adhesive (alternatively, the end cap may be inserted after epoxy curing operations depending on the requirements of the final operations in use). Adhering the fiber sleeve to the central surface of the central core by one of three methods: a low pressure bladder method, a high pressure bladder method, and a centrifugal force method (272) as described in the following paragraphs (272).

In one form, a method of constructing a hybrid baseball bat 100A (FIG. 2, 8) comprises the following steps (FIG. 18B) with each step listed in numeric (XXX) form. Obtaining a wood billet sufficient in length to make a one-piece full length wood shell. Trimming the wood billet to a predetermined length and cutting the external bat profile into the radial surface (250) (cutting profile can be delayed until the end). Forming the profiled central surface of the central core using a machine operation such as one or more of but not limited to: gun drilling, wood bit boring, and drilling with tapered drill bit (252). Optionally roughening the central surface by one or more operations such as rifling (254). Obtaining a formless fibrous sleeve substantially the length of the central core (294). If necessary, radially opening the fibrous sleeve using a forming stick inserted down its internal chamber to approximate the outer face with the central surface of the wood shell (264), Inserting the fibrous sleeve into the central core from the distal end of the wood shell and aligning to cover the exposed central surface (296). Removing the forming stick if not already removed. Pouring an epoxy mix down the central core (268) (alternatively, the fibrous sleeve may be pre-wetted with epoxy). Fixing the end cap at the distal end of the central core with adhesive (282) (alternatively, the end cap may be inserted after epoxy curing operations depending on the requirements of the final operations in use), Adhering the fiber sleeve to the central surface of the central core by one of three methods: a low-pressure bladder method, a high pressure bladder method, and a centrifugal force method as described in the following paragraphs (272).

In the low-pressure bladder method (FIG. 18, 18B), the process begins with sliding an expandable bladder into the internal chamber of the fibrous construct (274). Inflating the bladder thereby applying a low pressure (i.e. 10 psi) radial force (276) that causes a consequent embedding of the fiber sleeve in the central surface of the central core thus maximizing durability and minimizing potential delamination between the wood shell and sleeve during use. Using this method, the radial wall operates as the mold walls for the curing fibrous construct (i.e. fiber sleeve). Applying one or more optional measures such as beat and UV radiation to accelerate quality bonding (278). Removing the bladder after the epoxy cures (280). Fixing the end cap at the distal end of the central core with adhesives. Then forming a preferred external profile of the hybrid bat utilizing a wood bit in a standard or CNC lathe. Alternatively, the step of forming an external profile of the hybrid baseball bat may be completed as an earlier step in the hybrid baseball bat forming process.

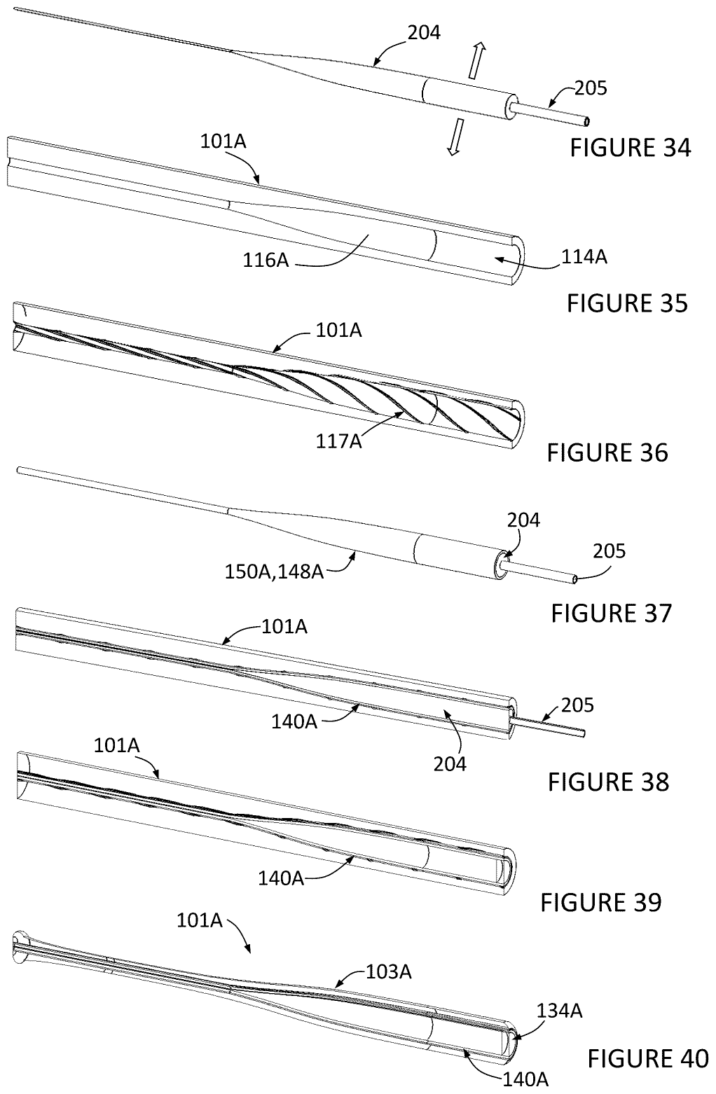

FIGS. 35-40 depict cross-sectional views of a hybrid baseball bat during various stages of manufacturing using the low-pressure bladder method. FIG. 34 illustrates one form of an inflatable (expandable) bladder 204 utilized in the hybrid baseball bat forming operations. On one end is an inlet 205 for inflating and deflating the bladder. Note that the bladder has an external contour of varied diameters for fit into the central core 114A of wood billet 101A (termed a wood billet vs a wood shell due to delayed cutting of external profile), FIG. 35 illustrates a wood billet 101A after gun drilling the central core, and in FIG. 36 with the optional step of roughening 117A the central surface. In FIG. 37 the fibrous sleeve 150A is pulled over the inflatable bladder and infiltrated with 2-part epoxy 148A. The fibrous sleeve and bladder are inserted into the central core then the bladder inflated to a low pressure (FIG. 38). Heat and pressure may be applied until fully cured. The bladder is deflated and removed (FIG. 39). The end cap is put in place, trimmed, and radial surface 112A profiled (FIG. 40).

In the high-pressure bladder method (FIG. 18A, 18B), the process begins with sliding an expandable bladder into the internal chamber of the fibrous construct (274). Placing the wood shell with core structure (i.e. fibrous construct, epoxy, flexible rod, joiner plug) into a first mold form 210 having a first hybrid bat cavity 211 (284) and fixably mating with a second mold form 212 having a second hybrid bat cavity 213 (285). Inflating the bladder thereby applying a high pressure (286) (i.e. 100 psi) radial force that causes a consequent embedding of the fiber sleeve in the central surface of the central core thus maximizing durability and minimizing potential delamination between the wood shell and sleeve during use. Here, the mold forms reinforce the radial wall of the wood shell preventing fracture as a result of the high internal bladder pressure. Applying one or more optional measures such as heat and UV radiation to accelerate quality bonding (278). Removing the hybrid baseball bat from the mold after the epoxy cures (288). Removing the expandable bladder after the epoxy cures (280). Fixing the end cap at the distal end of the central core with adhesives (282). Then, forming a preferred external profile of the hybrid bat utilizing a wood bit in a standard or CNC lathe. Alternatively, the step of forming an external profile of the hybrid baseball bat may be completed as an earlier step in the hybrid baseball bat forming process (250).

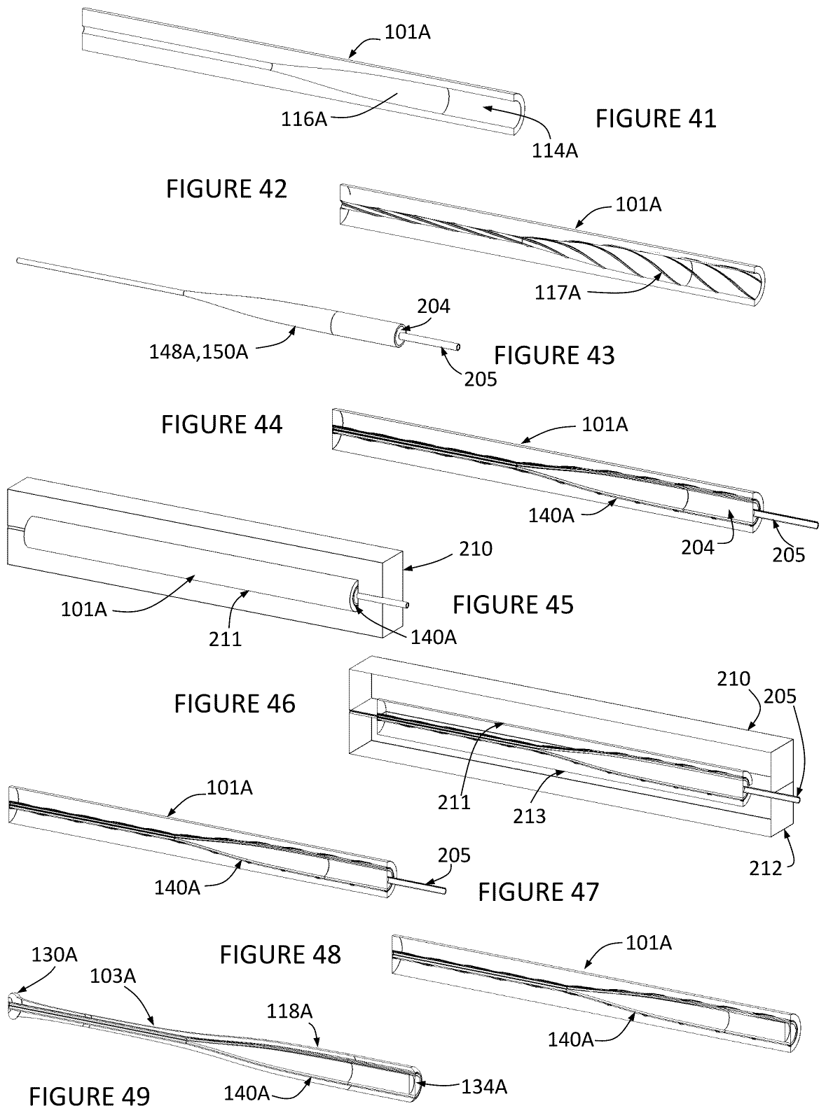

FIGS. 41-49 depict cross-sectional views of a hybrid baseball bat during various stages of manufacturing using the high-pressure bladder method. FIG. 41 illustrates a wood billet 101A after gun drilling the central core 114A and with the optional step of roughening 117A the central surface in FIG. 42. In FIG. 43 the fibrous sleeve 150A is pulled over the inflatable bladder 204 and infiltrated with 2-part epoxy 148A. The fibrous sleeve and bladder are inserted into the central core (FIG. 44). The billet is placed into the first bat cavity 211 of the first mold form 210 (FIG. 45). The mold is closed with the second mold form 212 aligning with the second bat cavity 213. The inflatable bladder 204 is inflated with high pressure at bladder inlet 205 with optional heat and pressure until fully cured (FIG. 46). The air pressure is released, the mold opened, and the billet 101A with core structure 140A is removed (FIG. 47), The inflatable bladder 204 is removed (FIG. 48). The end cap 134A is sealed in place, billet trimmed, and radial surface 112A profiled (FIG. 49).

The centrifugal force method begins (FIG. 18A, 18B) with seating the wood shell with core structure (i.e. fibrous construct, epoxy, flexible rod, joiner plug) into a rotary machine such as a lathe (290) and spinning the wood shell with core structure at a high RPM (292) to capture the effects of centrifugal force which propels mass (fibrous construct and epoxy-resin) in an outward direction embedding them into the central surface of the radial wall thereby maximizing durability and minimizing any prospect of delamination. As one example, the wood shell with core structure is spun for 5 minutes at approximately 1,800 rpms and then at 50 rpms until fully cured. The centrifugal method can also incorporate the step of applying one or more additional measures such as heat and UV light to accelerate curing (278). Fixing the end cap at the distal end of the central core with adhesives (282). Then forming a preferred external profile of the hybrid bat utilizing a wood bit in standard or CNC lathe. Alternatively, the step forming an external profile of the hybrid baseball bat may be completed as an earlier step in the hybrid baseball bat forming process (250). As a preference, the central axis of the wood shell is positioned substantially horizontal during spinning when using the centrifugal force method.

FIGS. 20-23 depict cross-sectional views of a hybrid baseball bat during various stages of manufacturing using the centrifugal force method. FIG. 20 illustrates a billet 101A after gun drilling and FIG. 21 after roughening 117A by rifling (optional) the central surface 116A. FIG. 22 illustrates the wood billet 101A with a fibrous sleeve 150A inserted in the central core of the wood billet 101A from the distal end to the proximal end and epoxy 148A poured in from the barrel end, end cap 134A inserted, and spun about axis A in a lathe 203 until cured. In this embodiment, the external profiling of the radial wall 110A is cut forming the completed hybrid baseball bat 100A before final finishing (FIG. 23).

FIGS. 24-27 illustrate typical turning lathe components plus specific drill features and a cored wood billet viewed from a distal end. FIG. 27 provides an illustration of the fibrous construct high strength material weave. This high strength material of FIGS. 27-29 can act as a sleeve over the central cavity coring means.

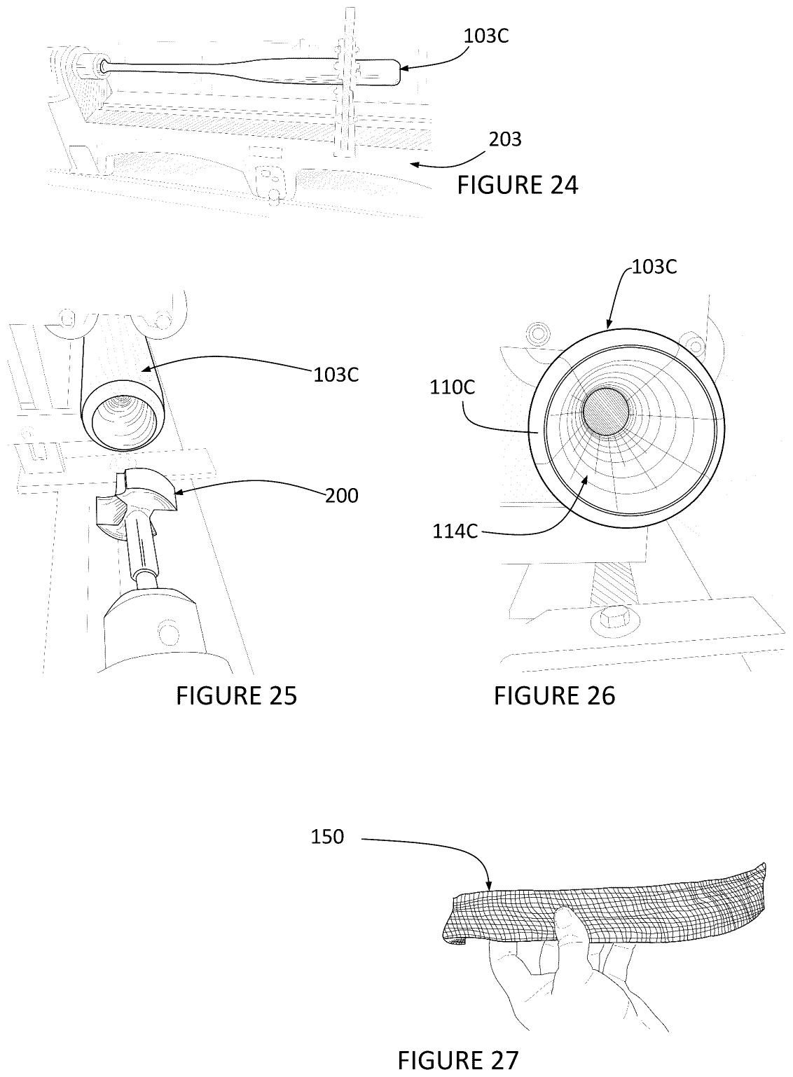

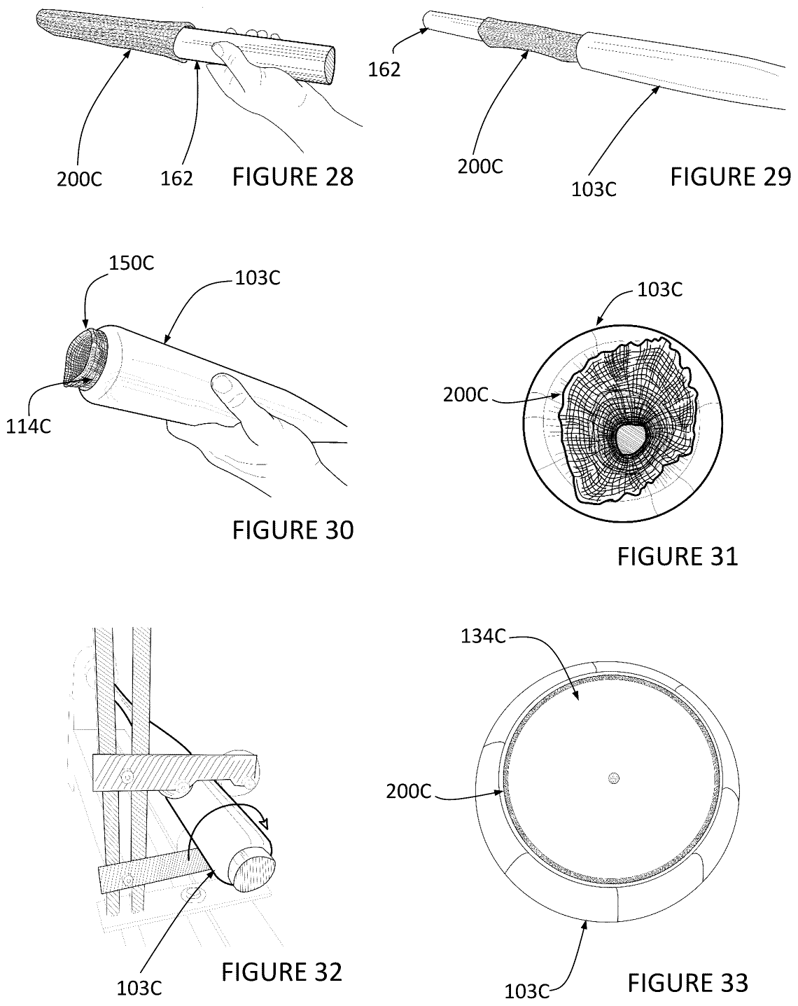

FIG. 24 illustrates a wood shell mounted in a lathe 203. In this embodiment, a forstner bit is utilized to begin cutting the central core 114C as illustrated in FIGS. 25 and 26. FIG. 27 illustrates one form of a flattened carbon fiber sleeve 150 in a pre-finished condition. The fibrous sleeve 150 is expanded to roughly a cylindrical shape before insertion into the central core. FIG. 28 illustrates the use of a forming stick 162 driven down the internal chamber 151 of the fibrous sleeve to reform it to be roughly cylindrical. The fibrous sleeve 150 is then guided into the central core 114C as illustrated in FIGS. 29-31. Epoxy 148 is poured into the central core 114C and the end cap 134C joined with the wood shell 103C. In one method, the wood shell 103C is then spun at high speed to disperse the epoxy into the central surface and fibrous sleeve (FIG. 32), The end cap 134C is trimmed (FIG. 33) and the exterior of the hybrid bat is treated with a wood finish,

FIGS. 30-31 provides a view of a simulated hybrid baseball bat shape with high strength fibrous weave extending out of the distal end of the hybrid baseball bat. FIGS. 32-33 illustrate the finishing turning operations to trim the end cap 134C and the fibrous construct 141C.

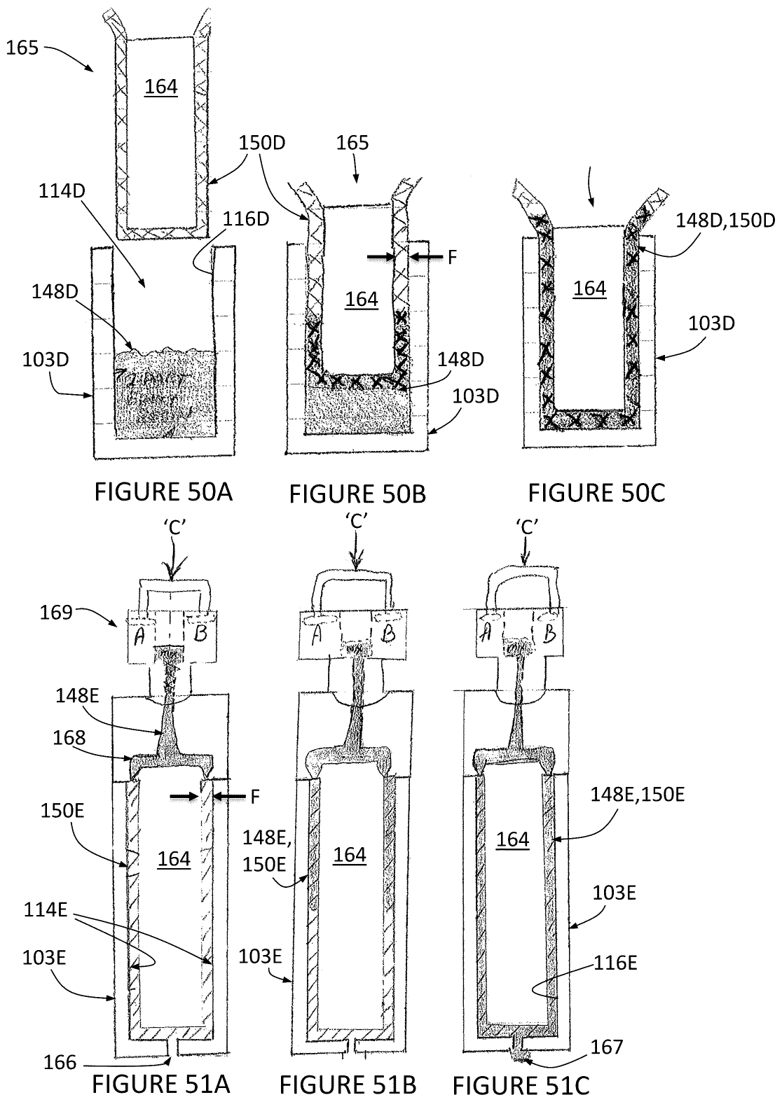

Additional novel methods of providing two-part epoxy resin infiltration into the fibrous construct material include but are not limited to; forced volume displacement (FVD) as viewed in FIG. 50, and high-pressure injection (HPI) as viewed in FIG. 51.

FIGS. 50A-50C depict the open end of hybrid baseball bat wood shell 103D having a central core 114D and a stepwise progression of the FVD method from left to right. As depicted in FIG. 50A, a two-part epoxy resin 148D in a metered volume is dispersed into an enclosed portion of central core 114D of the wood shell. A moveable plunger assembly 165, sized for sliding fit down central core 114D, comprises a central core body 164 enveloped by a fibrous sleeve 150D, and is advanced into central core 114D towards epoxy resin 148D as depicted in FIGS. 50B-50C. As plunger assembly 165 moves into central core 114D, two-part epoxy resin 148D is displaced and forced into the space ‘F’ causing infiltration into the fibrous sleeve 150D and non-fibrous pores as shown in FIG. 50B until core body 164 is fully inserted as shown in FIG. 50C. Once the plunger assembly 165 is fully inserted into central core 114D, the metered two-part epoxy resin becomes fully infiltrated and fully wetting the central surface 116D defining central core 114D. As depicted in FIG. 50C, core body 164 can either be removed after the two-part epoxy resin fully cures or can be left in place and become part of the finished hybrid baseball bat. Vibration dampening features are not shown in FIG. 50A-50C but anticipated when desired. FIGS. 50A-50C depicts a process only and not specific core details disclosed in other areas herein.

The HPI method of constructing a hybrid baseball bat is depicted in stepwise progression from left to right in FIGS. 51A-51C. The open end of a hybrid baseball bat wood shell 103E comprises a central core 114E which is lined with fibrous sleeve 150E. An epoxy injector 169 responsible for injecting a 2-part epoxy 148E (part ‘A’ and part ‘B’) is utilized and comprises a core body 164 sized to create a space ‘F’ between wood shell 103E and the core body for seating fibrous sleeve 150E therein. Cylindrical core body 164 extends from the epoxy injector. Two-part epoxy resin 148E is metered by injection time or stoke or discharge at end vent 166. End vent 166 can be equipped with a vacuum if so desired. The two-part epoxy 148E is injected into space ‘F’ causing infiltration into the fibrous construct and non-fibrous pores as shown in FIG. 51B until fully inserted as shown in FIG. 51C. Once the two-part epoxy becomes fully infiltrated, it fully wets central surface 116. As shown in FIG. 51C, core body 164 can either be removed after the two-part epoxy resin fully cures or in some cases can be left in place and become part of the finished hybrid baseball bat. Vibration dampening features are not shown in FIG. 51A-51C but anticipated when desired. FIGS. 51A-51C depict a process only and not specific core details disclosed in other areas herein.

The are several variations of these processes as described below.

### REMOVABLE Core Body Leaving Flex Rod:

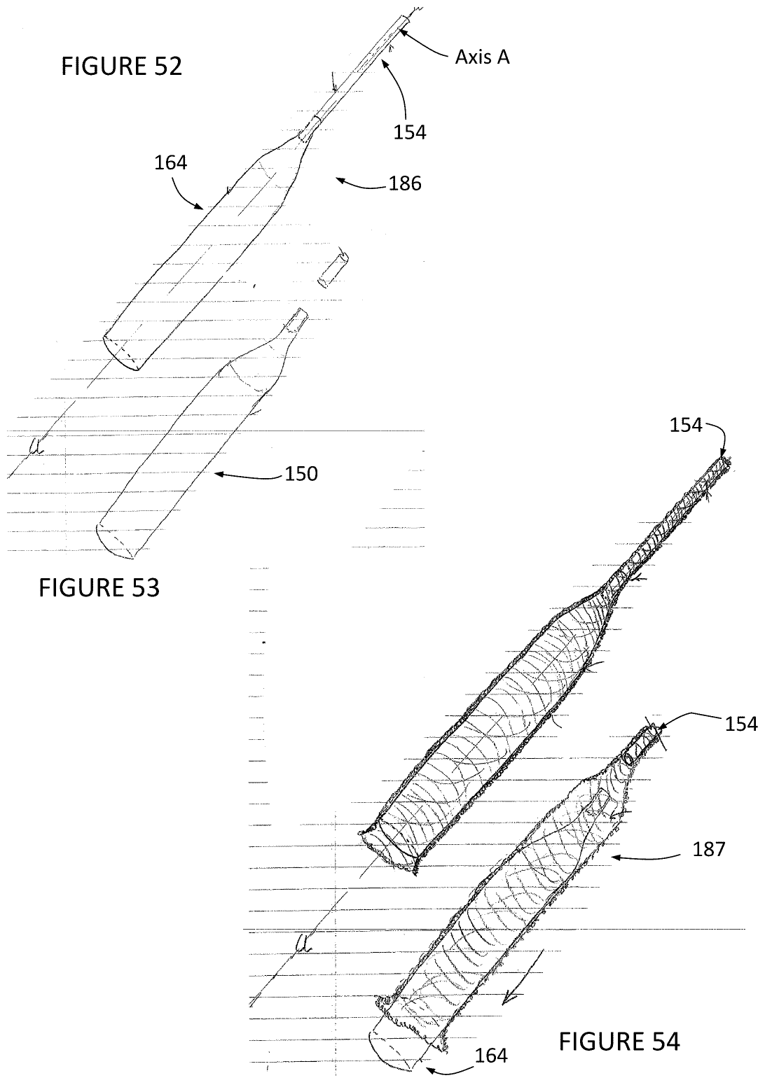

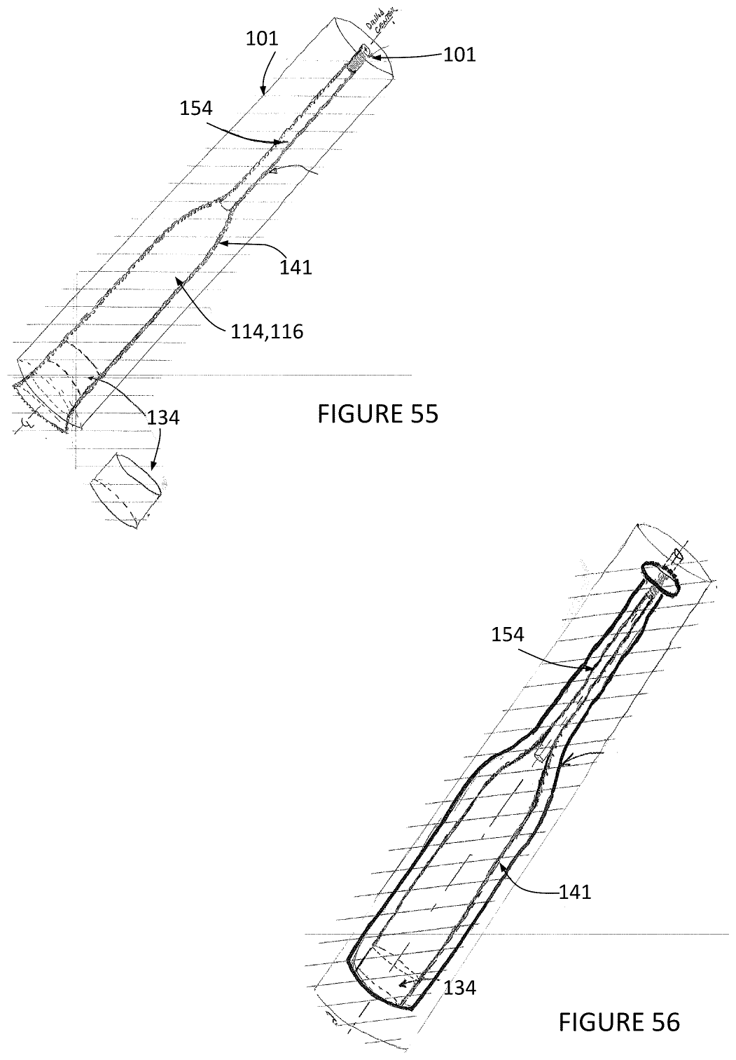

FIG. 52 depicts a core-rod assembly 186. The core-rod assembly consists of a flex rod 154 coupled with a removeable core body 164. Core-rod assembly 186 is inserted into fibrous sleeve 150 as shown in FIG. 54. Fiberous core-rod assembly 187 is then inserted into the central core 114 as noted in FIG. 55 to become completely embedded and the fibrous construct 141 fully infiltrated. Once the two-part epoxy resin has cured and becomes solid, the core body 164 can be removed leaving the flex rod 154 and the complete fibrous construct 141 (fiberous sleeve with epoxy) as a cure in-place component. The flex rod 154 and fibrous construct is now bonded to central surface 116. The central core area along with the flex rod 154 and fibrous construct 141 is shown within the originating wood billet 101 in FIG. 55 along with the distal end cap (plug) 134. The completed hybrid baseball bat is shown in FIG. 56 is within the complete wood billet 101 for a fuller view of the manufacturing sequence. Using a removeable core prior to installation of the distal end plug 134 can include three extra steps in manufacturing. These steps are: 1. allowing the two-part resin to cure and then remove the core, 2. re-wetting the distal end fibrous ends prior to installation of the end plug 134 and 3. installation of end plug 134 after steps 1 & 2.

### Removable Core Body Leaving the Flex Rod & Vibration Dampening Plug:

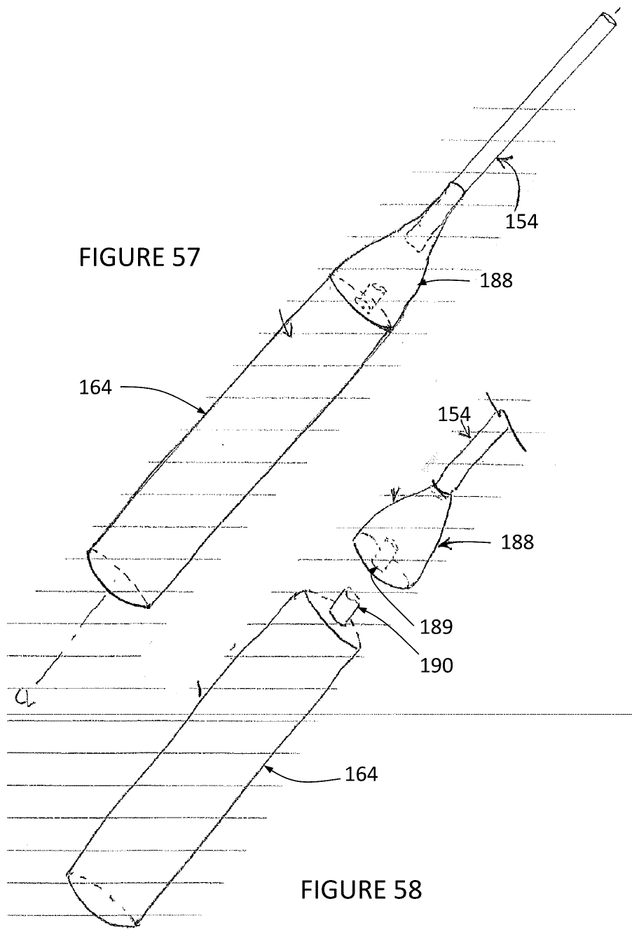

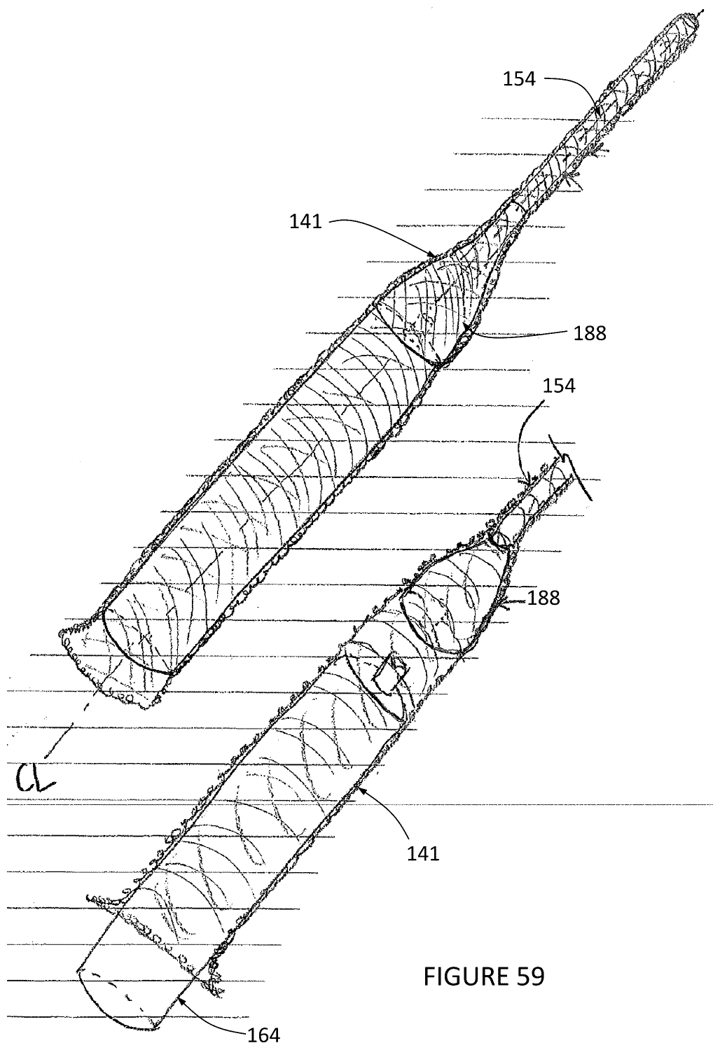

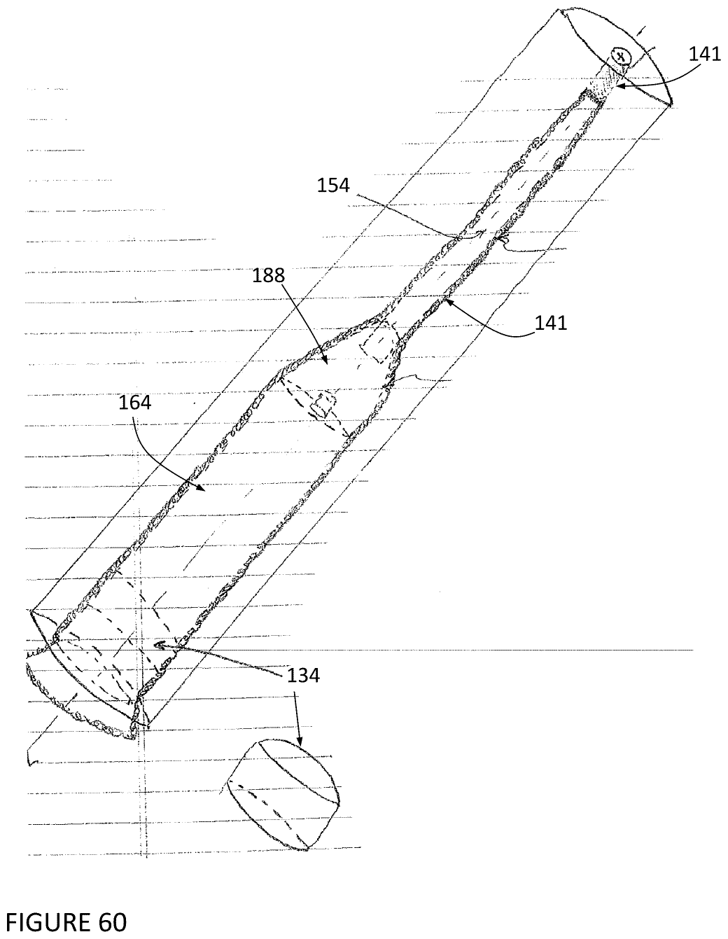

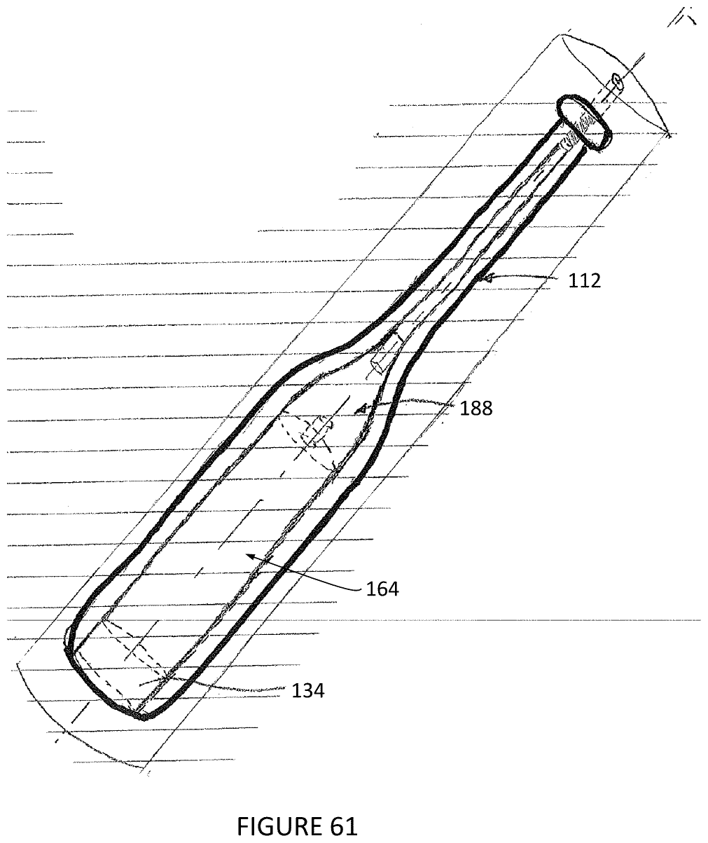

FIGS. 57-61 depict the same sequence of manufacture of FIGS. 52-56 except with the addition of vibration dampening plug 188. Vibration dampening plug 188 is an additional component of the core-rod assembly 186 and remains within the central core 114 when core body 164 is removed. Vibration dampening plug 188 is configured for coupling between flex rod 154 and core body 164 but is separated from core body 164 following curing of the epoxy. A dampening plug receiver hole 189 and a dampening plug post 190 may be utilized for mating therebetween. Using a removeable core body 164 prior to installation of the distal end plug 134 will require three extra steps in manufacturing. These steps are: 1. allowing the two-part resin to cure and then remove the core, 2, re-wetting the distal end fibrous ends prior to installation of the end plug (cap) 134 and 3. installation of end plug 134 after steps 1 & 2.

### Permanent Foam Barrel Core and FLEX ROD Assembly:

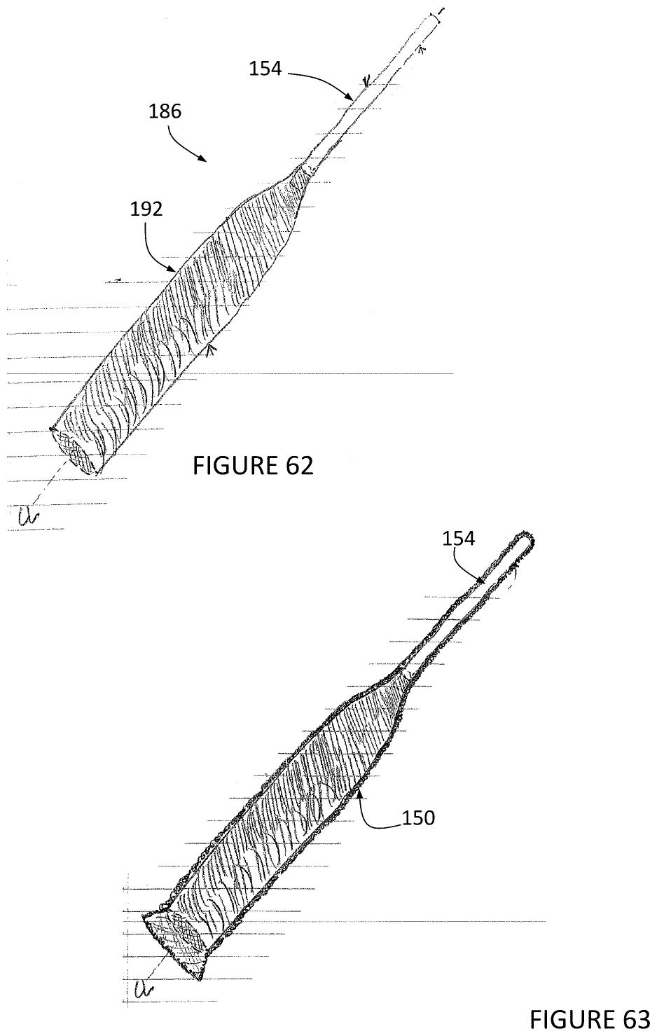

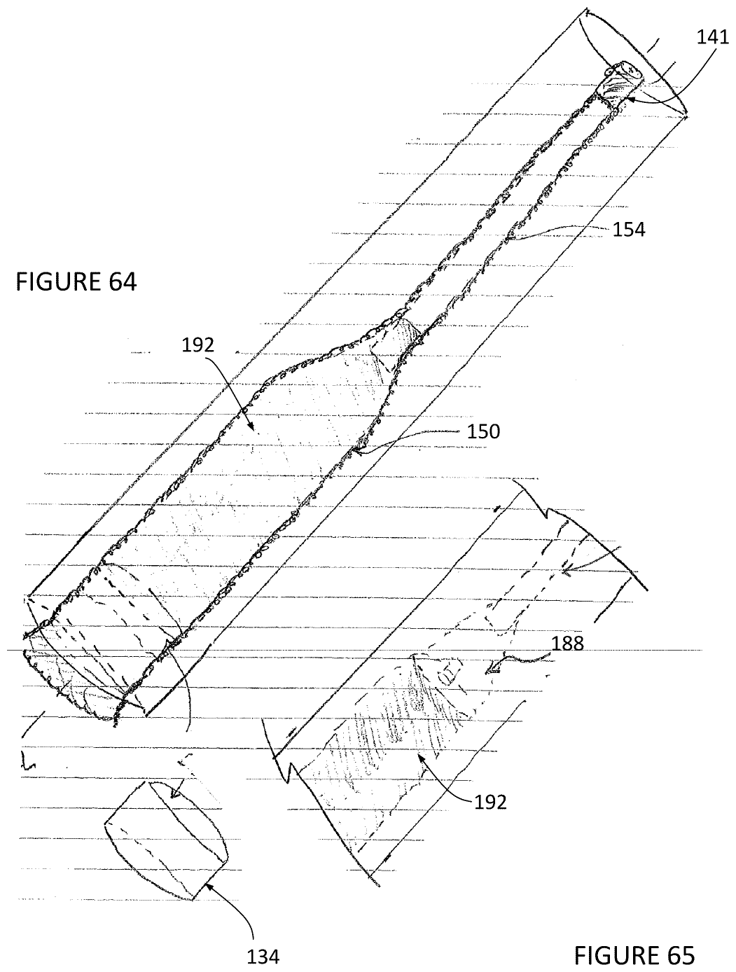

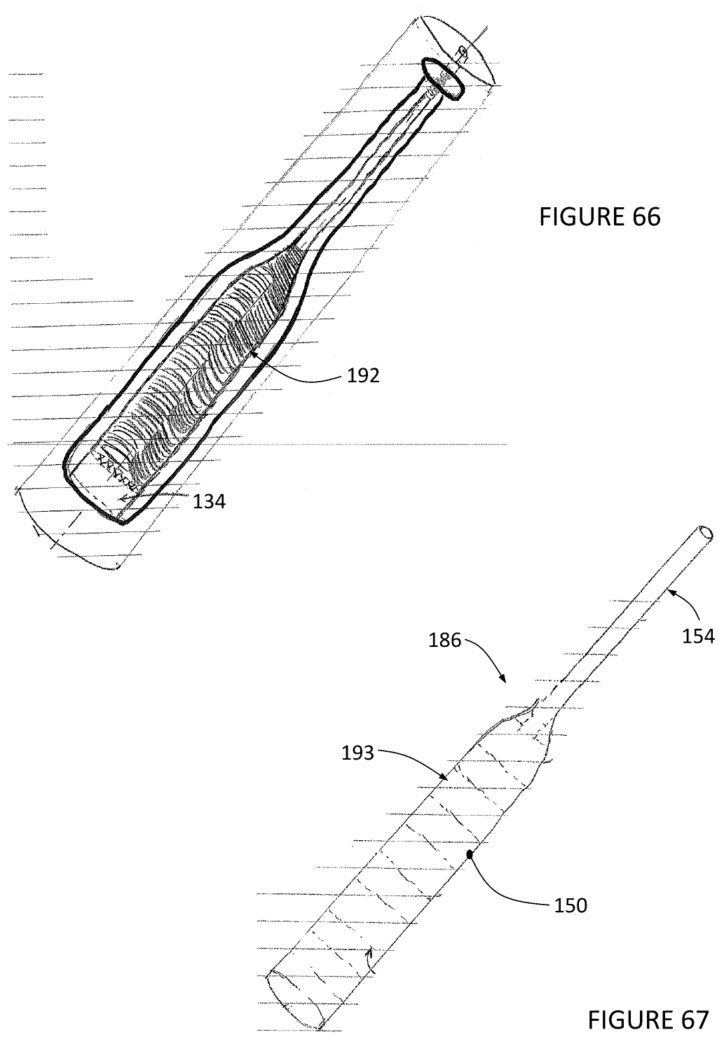

FIGS. 62-66 depict similar shaped and sized central core assemblies (with and without vibration dampening) as illustrated in FIGS. 52-61 except the complete core-rod assembly 186 utilizes a core body in the form of a foam barrel 192 coupled with flexible rod 154. In this case, foam barrel 192 remains in place and becomes part of the finished hybrid baseball bat 100 as depicted in FIG. 2. End plug 134 can be installed in the central core.

### PERMANENT 3D Printed Barrel and FLEX ROD Assembly:

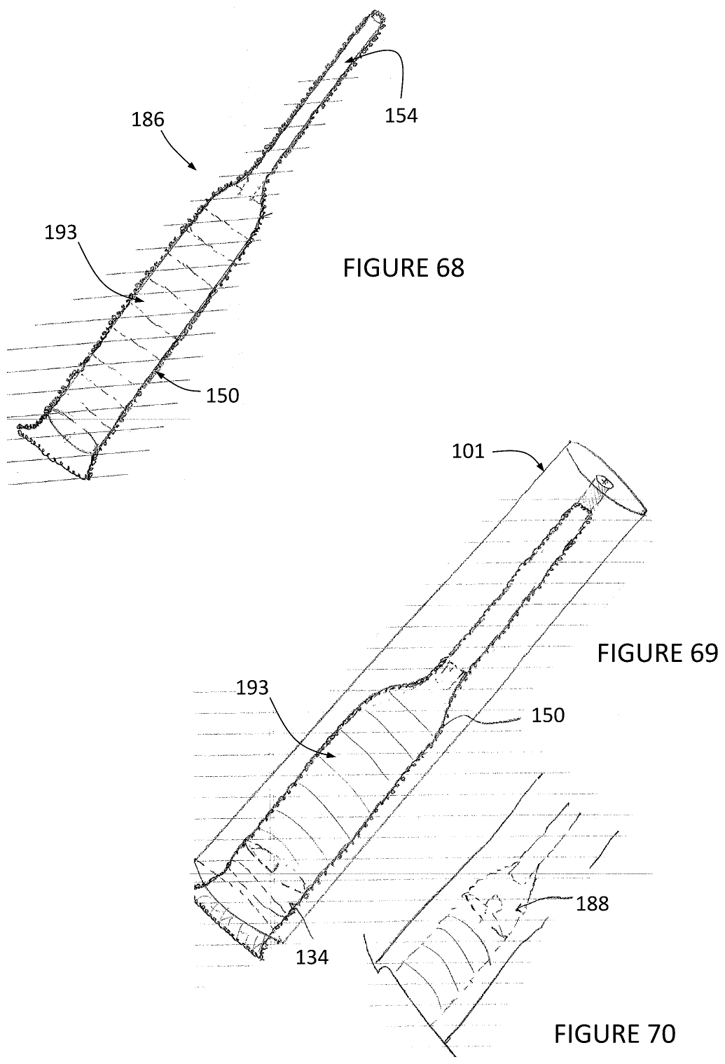

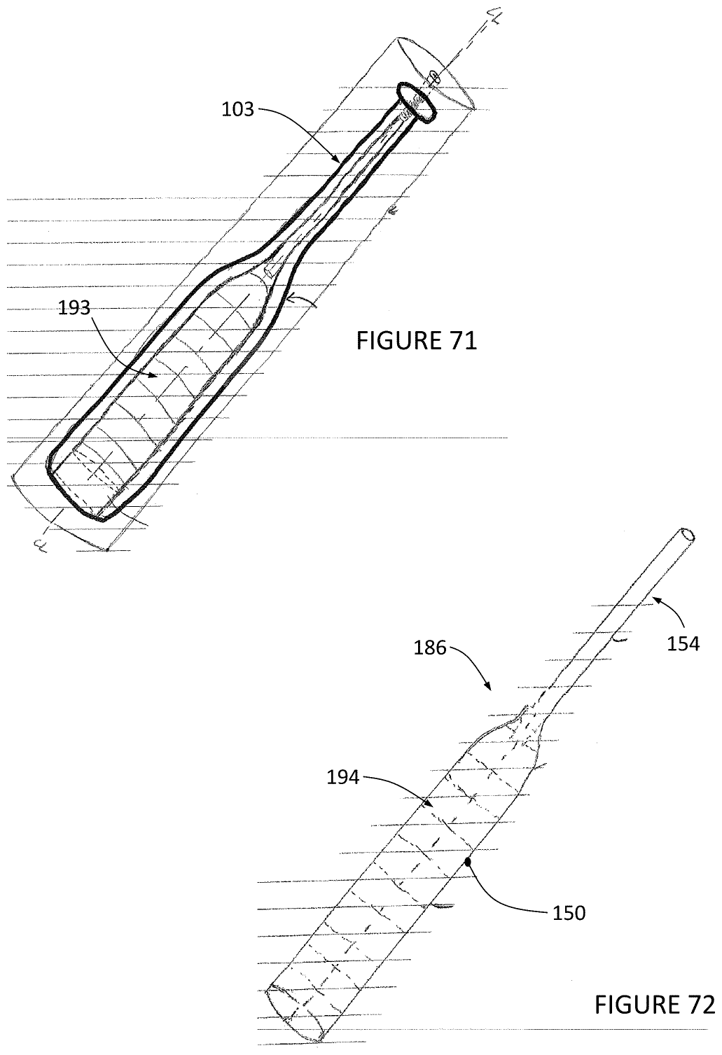

FIGS. 67-71 depict similar shaped and sized central core assemblies 138 (with and without vibration dampening) as illustrated in FIGS. 52-61 except the core-rod assembly 186 utilizes a core body in the form of a hollow 3D printed barrel 193 coupled with flex rod 154. In this case, 3D printed barrel 193 will remain in place and become part of the finished hybrid baseball bat article 100 as depicted in FIG. 2. End plug 134 can be installed directly following installation of the core-rod assembly 186.

### Permanent Half-Shell Injection Molded Barrel Core and FLEX ROD Assembly:

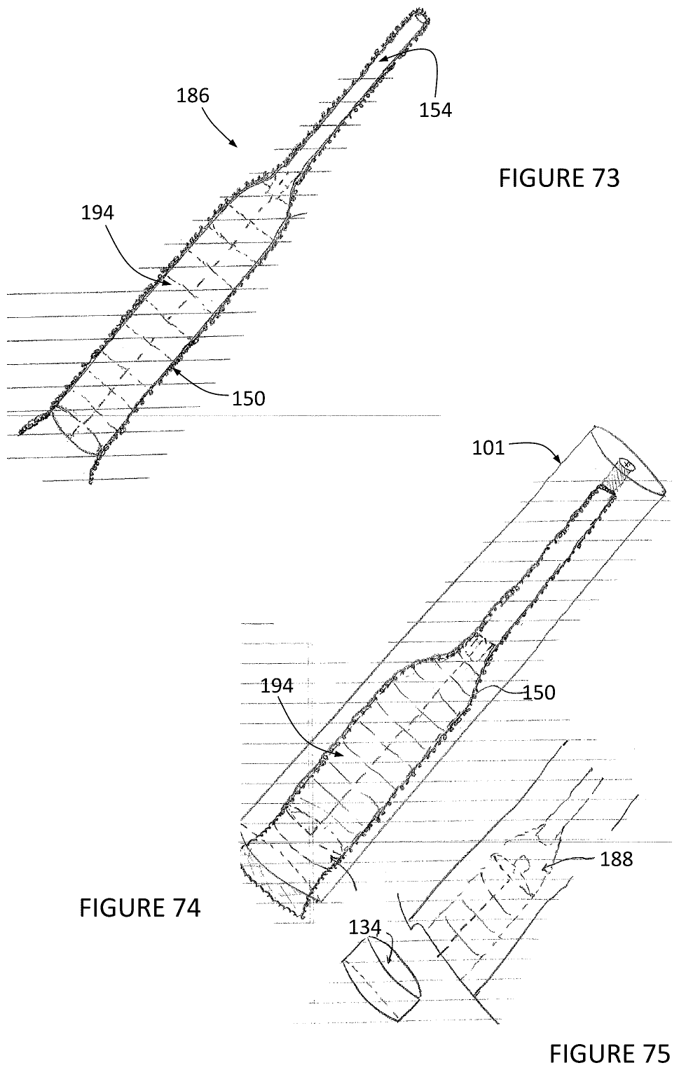

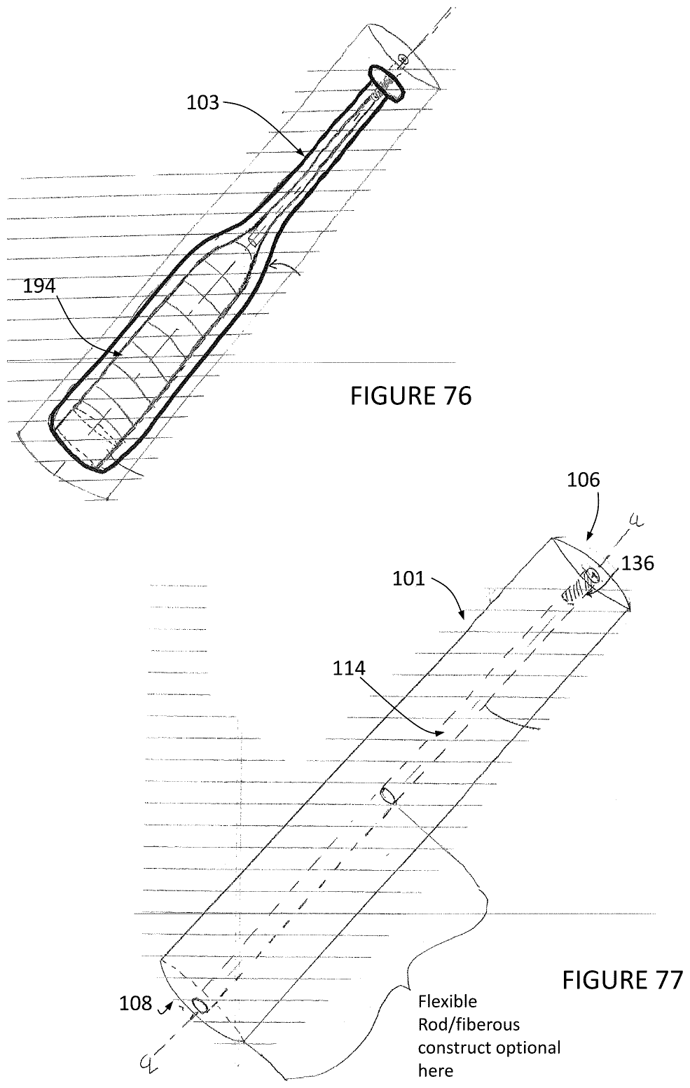

FIGS. 72-76 depict similar shaped and sized central core assemblies (with and without vibration dampening) as illustrated in FIGS. 52-61 except the core-rod assembly 186 utilizes a core body in the form of an injection molded barrel 194 with flex rod 154. In this case, injection molded barrel 193 will remain in place and become part of the finished hybrid baseball bat article 100 of FIG. 2. End plug 134 can be installed directly following installation of the core-rod assembly 186.

### Tethered Central Cavity Core:

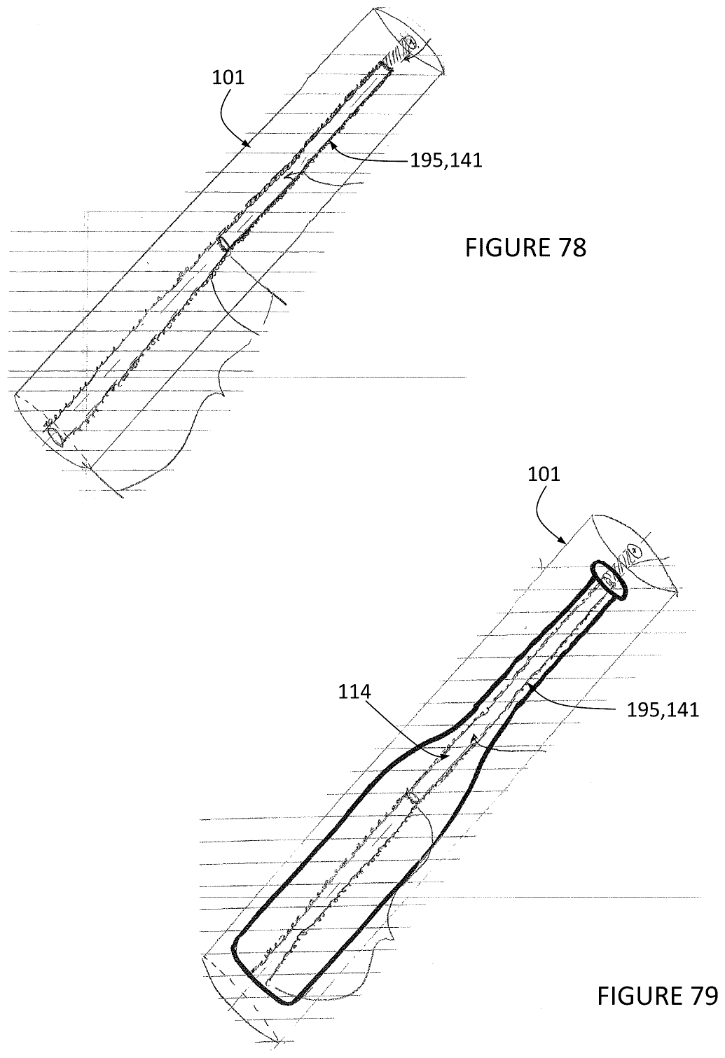

Note FIGS. 77-79. A standard wood billet 101 has a central core 114 drilled at least partially from a first billet end 106 (proximal) towards a second billet end (distal end) 108 as illustrated in FIG. 77. This central core 114 forms a uniform diameter on the center line of wood billet 101. Tethered assembly 195 is added as depicted in FIG. 41B utilizing the same manufacturing steps identified previously to add a fibrous sleeve 150 around a flexible rod 154 (tethered assembly 195) and installing the flex rod and fibrous sleeve into the central core. The flexible rod 154 can comprise but is not limited to, high tensile thermoplastics, high strength carbon fibers, flexible thermoplastic elastomeric, fiberglass strands, or chain links. FIG. 41C is an illustration of the hybrid baseball bat with its tethered core shown inside wood billet 101. The portion of the wood billet 101 around the hybrid baseball bat is the wood material removed from wood billet 101 during the machining process.

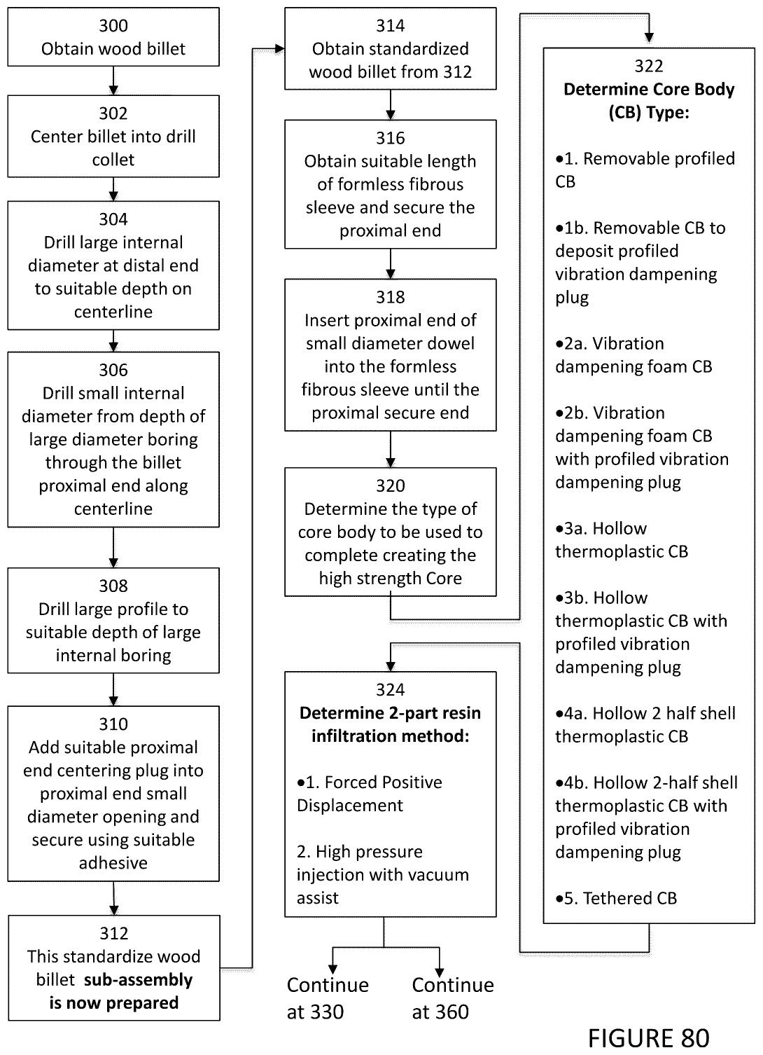

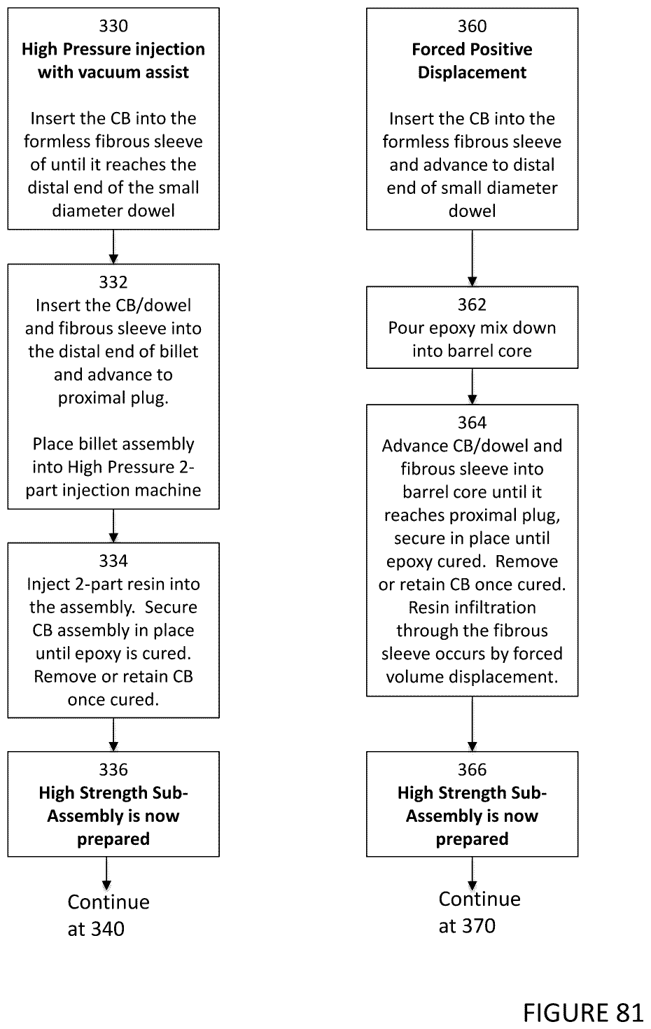

Additional embodiments of methods for constructing a hybrid baseball bat are as follows according to the methods depicted in FIGS. 80-82. Obtain a wood billet (300), center the billet in a drill collet such as on a lathe (302). Drill into the distal end of the billet on the centerline, a large internal diameter bore to form a barrel core (304). Drill a small internal diameter bore along the centerline from the large diameter boring through the billet proximal end (306). Drill a large profile to suitable depth of large internal boring (308). Secure a proximal plug with adhesive in proximal end bore (310). This completes the standardized wood billet sub-assembly (312). Obtain the billet from step 312 (314). Obtain a suitable length of formless fibrous sleeve and secure the proximal end (316). Insert the proximal end of small diameter dowel into the formless fibrous sleeve until the proximal secure end (318). Determine the type of core body to be used to complete creating the high strength core (320). Choose one of the following core body types: 1. Removable profiled core body, 1b. Removable core body to deposit profiled vibration dampening plug, 2a. vibration dampening foam core body, 2b. vibration dampening foam core body with profiled vibration dampening plug, 3a. hollow thermoplastic core body, 3b. hollow thermoplastic core body with profiled vibration dampening plug, 4a. hollow 2-half shell thermoplastic core body, 4b. hollow 2-half shell thermoplastic core body with profiled vibration dampening plug, and 5, tethered core body (322). Determine the 2-part resin infiltration method to be used, forced positive displacement or high-pressure injection with vacuum assist (324). If using high pressure injection with vacuum assist: insert the core body into the formless fibrous sleeve until it reaches the distal end of the small diameter dowel (330). Insert the core body/dowel and fibrous sleeve into the distal end of the billet and advance to the proximal plug (332). Inject 2-part epoxy resin into the assembly then secure the core body assembly in place until the epoxy is cured and removed or retain the core body once it is cured (334). The high strength sub-assembly is now prepared (336). Obtain the standardized wood billet with high strength core from step 336 (340). Roughen the central surface of the distal end of the assembly (342). Insert the distal end cap into the assembly and secure in place using adhesive (344). Cut assembly of step 344 into suitable length to support bat length choice (346). Cut external bat profile using a suitable lathe. Sand and harden external bat profile in preparation for adding appropriate finish coating and decals (348). Apply bat finish coating, decals, and lazar etching as appropriate (349). The bat is complete (350). Alternatively, after step 324 and if using forced positive displacement, insert the core body into the formless fibrous sleeve and advance to distal end of the small diameter dowel (360). Pour epoxy mix into barrel core (362). Advance the core body/dowel and fibrous sleeve into the barrel core until it reaches the proximal plug. Secure core body and sleeve in place until the epoxy is cured. Remove or retain the core body once the epoxy is cured. Resin infiltration through the fibrous sleeve occurs by forced volume displacement (364). The high strength sub-assembly is now prepared (366). Obtain the standarized wood billet with high strength core from step 366 (370). Roughen the central surface of the distal end of the assembly (372). Insert distal end cap into billet and secure with adhesive (374). Cut bat assembly to a length of choice (376). Cut the external bat profile using a suitable lathe. Sand and harden the external bat profile in preparation for adding finish coating and decals (378). Apply bat finish coating, decals and lazar etching (380). The bat is complete (382).

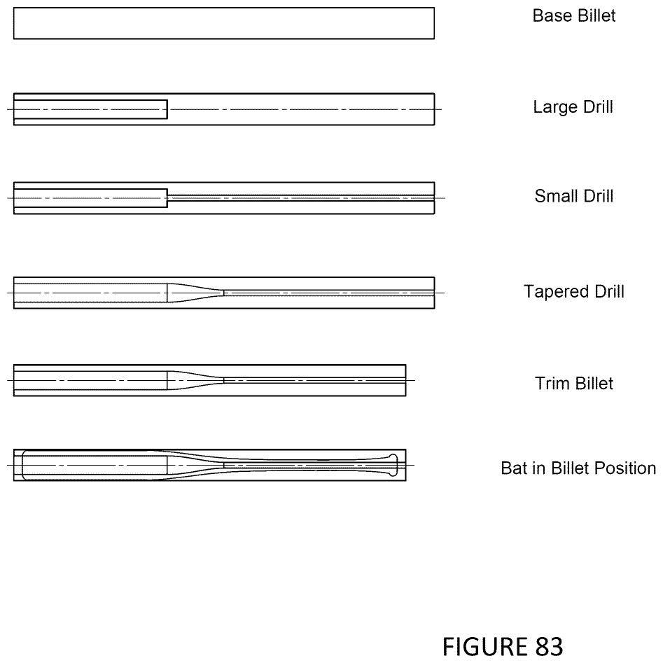

In one embodiment, FIG. 83 depicts a progression of cross-sectional views of a billet following a series of machine operations before the outer surface of the billet is machined.

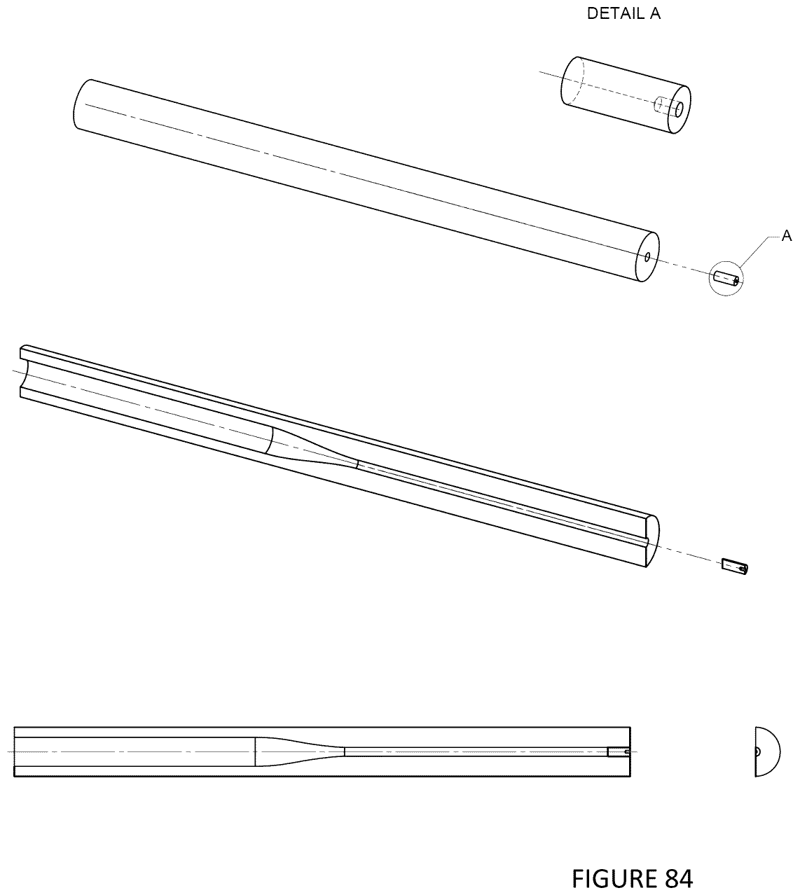

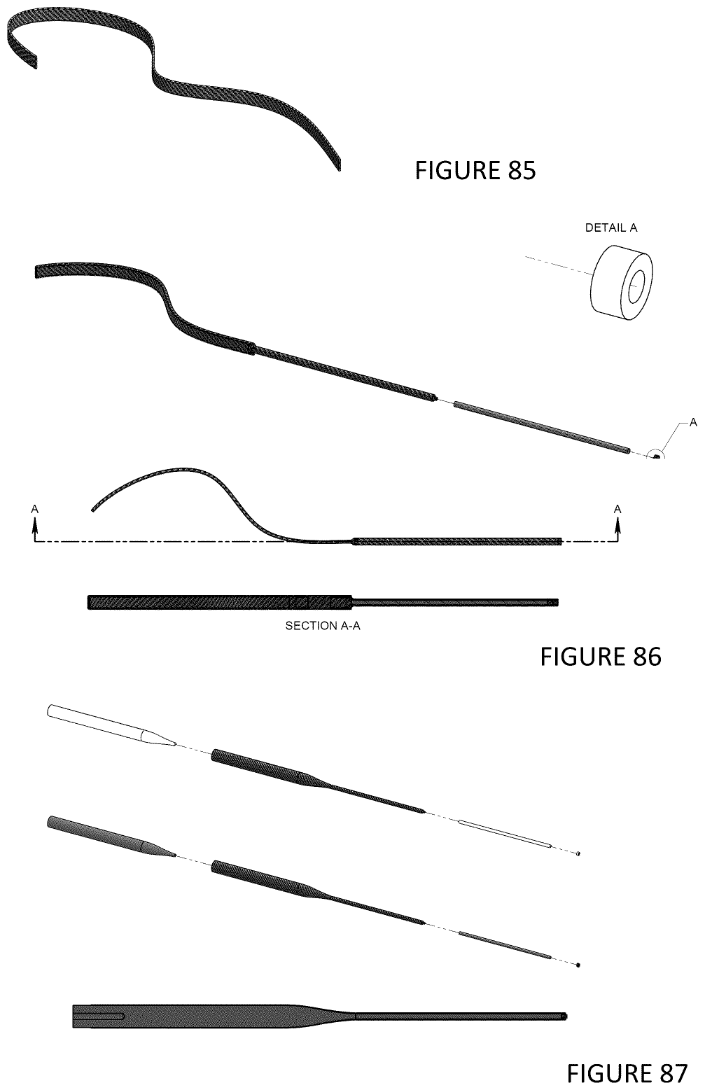

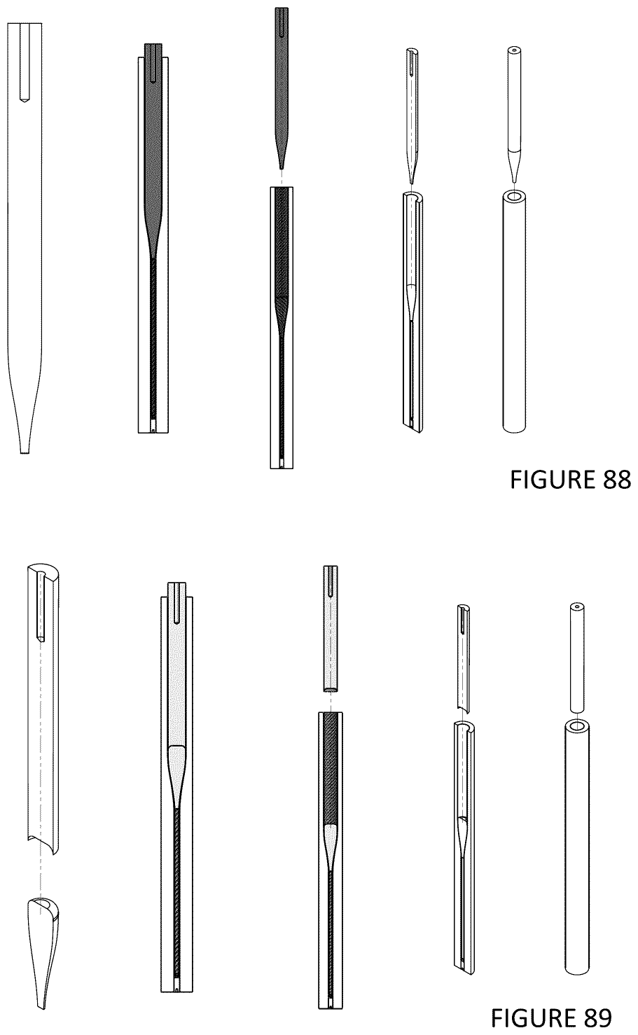

FIG. 84 depicts a perspective view of a proximal plug in detail A wherein the proximal plug is seated in the handle core of the billet as further depicted in the lower cross-sectional views. This is further described at step (310). FIG. 85 depicts a perspective view of formless fiberous sleeve. This is further described at step (316). FIG. 86 depicts views of a dowel (and forming stick) inserted into the fiberous sleeve depicted in FIG. 85. This is further described at step (318). FIG. 87 depicts a perspective view of a dowel and a core body seated in the interior of the fiberous sleeve. This is further described at step (318). FIG. 88 depicts a series of cross-sectional and perspective views of steps in the manufacture of a baseball bat using a removable profiled core body. Note step (322-1) as described previously.

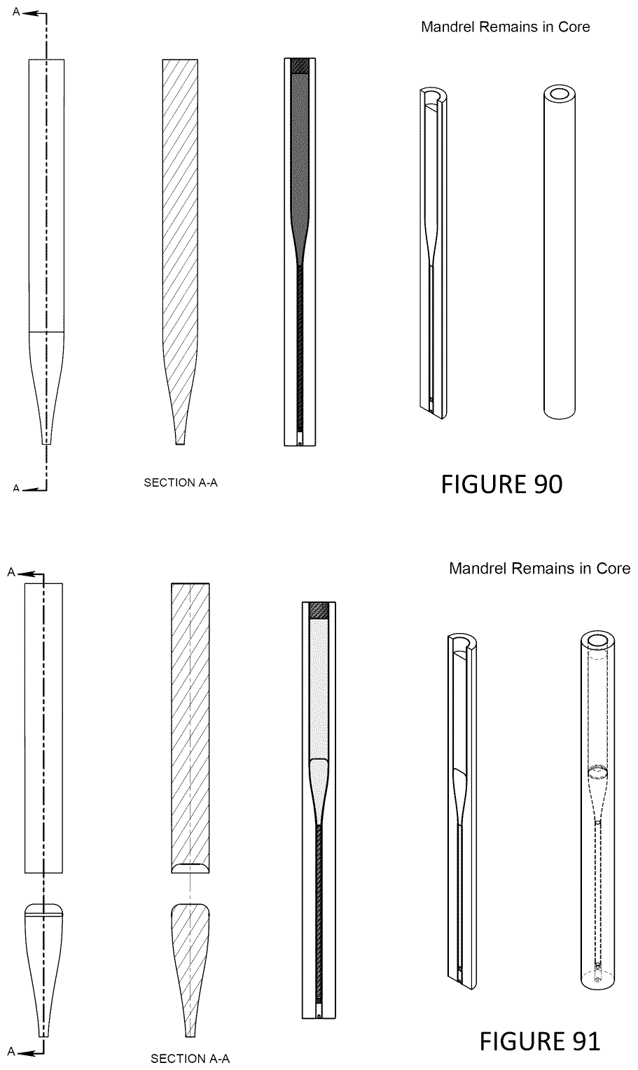

FIG. 89 depicts a series of cross-sectional and perspective views of steps in the manufacture of a baseball bat using a removable core body to deposit a profiled vibration dampening plug. Note step (322-1b) as described previously. FIG. 90 depicts a series of cross-sectional and perspective views of steps in the manufacture of a baseball bat using a vibration dampening foam core body. Note step (322-2a) as described previously.

FIG. 91 depicts a series of cross-sectional and perspective views of steps in the manufacture of a baseball bat using a vibration dampening foam core body with profiled vibration dampening plug. Note step (322-2b) as described previously.

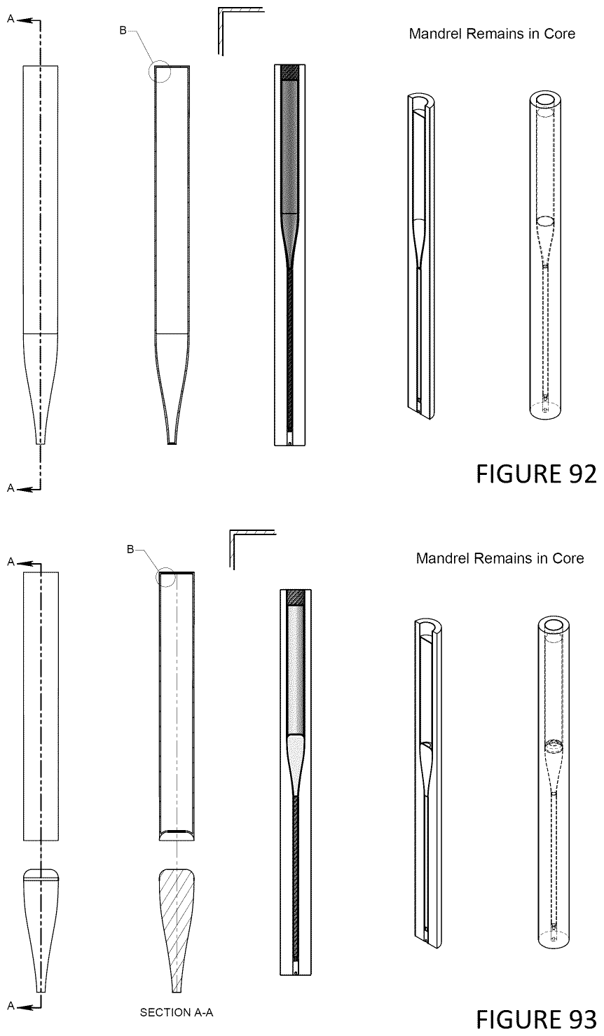

FIG. 92 depicts a series of cross-sectional and perspective views of steps in the manufacture of a baseball bat using a hollow thermoplastic core body. Note step (322-3a) as described previously.

FIG. 93 depicts a series of cross-sectional and perspective views of steps in the manufacture of a baseball bat using a hollow thermoplastic core body with profiled vibration dampening plug. Note step (322-3b) as described previously.

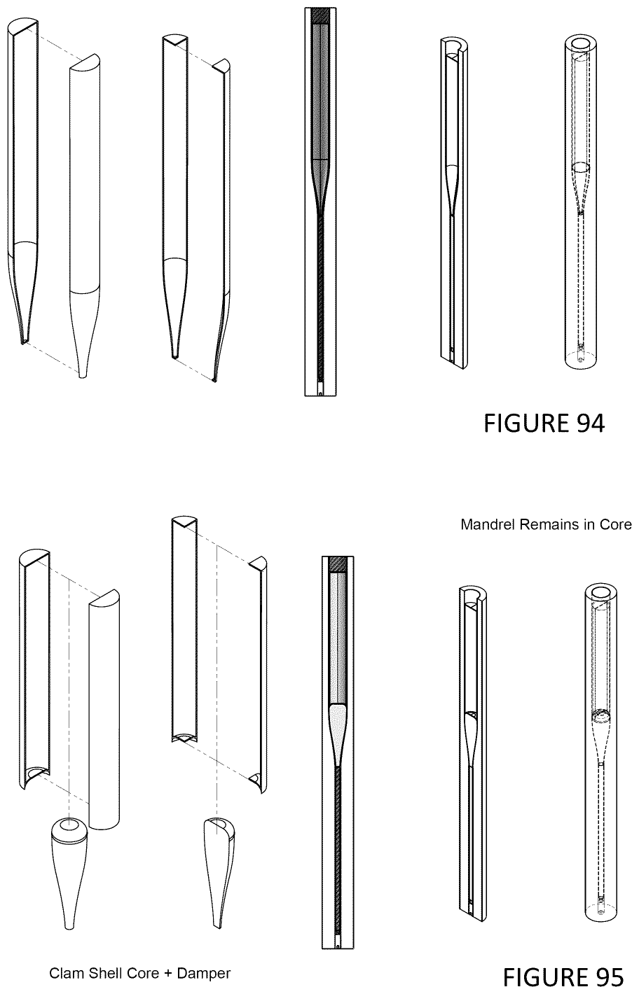

FIG. 94 depicts a series of cross-sectional and perspective views of steps in the manufacture of a baseball bat using a hollow 2-half shell thermoplastic core body. Note step (322) as described previously. Note step (322-4a) as described previously.

FIG. 95 depicts a series of cross-sectional and perspective views of steps in the manufacture of a baseball bat using a hollow 2-half shell thermoplastic core body with profiled vibration dampening plug. Note step (322-4b) as described previously.

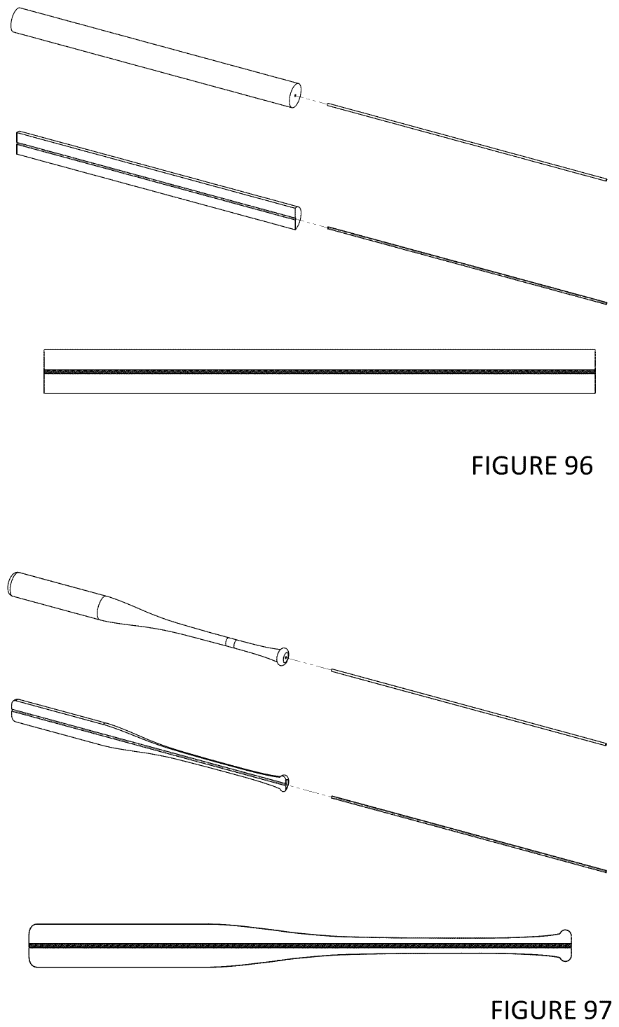

FIG. 96 depicts cross-sectional and perspective views of steps in the manufacture of a baseball bat using a tethered core body. Note step (322-5) as described previously.

FIG. 97 depicts cross-sectional and perspective views of a fully tethered bat.

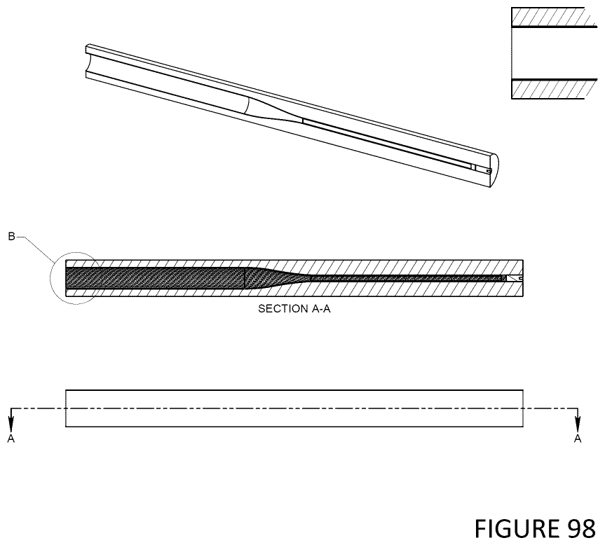

FIG. 98 depicts cross-sectional views of a billet with fiberous core seated therein.

If desired, at the completion of other manufacturing operations, one or more of the radial surfaces, end cap, and proximal end of the hybrid bat can be finished with one or more of stains and sealants.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A hybrid baseball bat comprising:
a wood shell extending along a central axis;
said wood shell having a proximal end and a distal end;
said wood shell of one-piece construction;
said wood shell having a radial surface on the outside of the wood shell;
said radial surface defining the form of a baseball bat;
a central core centered in said wood shell;
said central core defined by a central surface on said wood shell;
said central core comprising a barrel portion extending from said distal end;
said central core comprising a handle portion extending from the proximal end;
whereas the diameter of the central core of said barrel portion is larger than said handle portion;
a flexible rod configured to fit within said handle portion;
one end of said flexible rod fixed extends into said central barrel portion;
an elongated woven fibrous sleeve;
said woven fibrous sleeve having an inner face defining an internal chamber of said woven fibrous sleeve;
said woven fibrous sleeve having an outer face defining an external surface of said woven fibrous sleeve;
said elongated woven fibrous sleeve extends substantially from the handle proximal end to the barrel distal end;
said flex rod is housed in said internal chamber starting at the proximal end of said woven fibrous sleeve;
two-part epoxy embedded within said woven fibrous sleeve; and
said woven fibrous sleeve having an outer face circumferentially embedded against said central surface of said barrel portion and said handle porting by application of outward radial forces from said central axis and bonded by said two-part epoxy.

2. A hybrid baseball bat of claim 1 whereas the distal end of the flex rob is aligned approximately on the central axis.

3. A hybrid baseball bat of claim 1 where the central core barrel portion from the central axis to the said woven fibrous weave/two-part epoxy bond is void of any materials.

4. A hybrid baseball bat of claim 1 whereas said outward radial force is a consequence of volume displacement utilized to embed said fibrous sleeve in said central surface.

5. A hybrid baseball bat of claim 1 whereas said outward radial force is a result of high pressure injection utilized to embed said fibrous sleeve in said central surface.

6. A hybrid baseball bat comprising:
a wood shell extending along a central axis;
said wood shell having a proximal end and a distal end;
said wood shell of one-piece construction;
said wood shell having a radial surface on the outside of the wood shell;
said radial surface defining the form of a baseball bat;
a central core centered in said wood shell;
said central core defined by a central surface on said wood shell;
said central core comprising a barrel portion extending from said distal end;
said central core comprising a handle portion extending from the proximal end;
whereas the diameter of the central core of said barrel portion is larger than said handle portion;
a flexible rod configured to fit within said handle portion;
said joiner plug extends substantially from the distal end of the flex rod to the distal end of the barrel portion;
said joiner plug comprising a plug aperture along a central axis of said joiner plug;
one end of said flexible rod is fixed or proximal in/to said plug aperture;
an elongated woven fibrous sleeve;
said woven fibrous sleeve having an inner face defining an internal chamber of said woven fibrous sleeve;
said elongated woven fibrous sleeve extends substantially from the handle proximal end to the barrel distal end;
said flex rod and joiner plug housed in said internal chamber of said woven fibrous sleeve;
two-part epoxy embedded within said woven fibrous sleeve; and
said woven fibrous sleeve having an outer face circumferentially embedded against said central surface by application of outward radial forces from said central axis and bonded by said two-part epoxy.

7. A hybrid baseball bat of claim 6 where the joiner plug consists of a pre-shaped foam core.

8. The pre-shaped foam core of claim 7 has a density range of 3 grams/cubic inch to 10 grams/cubic inch.

9. The pre-shaped foam core of claim 7 consists of vibration dampening foam.

10. A hybrid baseball bat of claim 6 where the joiner plug consists of a 3D printed core.

11. The 3D printed core of claim 10 consists of but not limited to, polymer material, foam material, thermoplastic material, two-part thermoset material, paper and any combination thereof.

12. The 3D printed core of claim 10 consists of vibration dampening, performance enhancing, performance tuning structure and/or materials of any shape or geometry or any combinations thereof.

13. A hybrid baseball bat of claim 6 where the joiner plug consists of a two-half shell plastic injected parts.

14. The plastic injected parts of claim 13 consists of two plastic half-shells assembled to form a complete and liquid tight plastic core.

15. The plastic injected parts of claim 13 consists of, but not limited to, polymer material, foam material, thermoplastic material, two-part thermoset material, paper and any combination thereof.

16. A Hybrid baseball bat of claim 6 whereas said outward radial force is a consequence of volume displacement utilized to embed said fibrous sleeve in said central surface.

17. A hybrid baseball bat of claim 6 whereas said outward radial force is a result of high pressure injection utilized to embed said fibrous sleeve in said central surface.

18. A hybrid baseball bat comprising:
a wood shell extending along a central axis;
said wood shell having a proximal end and a distal end;
said wood shell of one-piece construction;
said wood shell having a radial surface on the outside of the wood shell;
said radial surface defining the form of a baseball bat;
a central core centered in said wood shell;
said central core defined by a central surface in said wood shell;
said central core may be comprising a barrel portion extending from said distal end;
said central core comprising a handle portion extending from the proximal end;
a flexible rod configured to fit within said central core;
an elongated woven fibrous sleeve;
said woven fibrous sleeve having an inner face defining an internal chamber of said woven fibrous sleeve;
said flex rod is housed in said internal chamber of said woven fibrous sleeve;
two-part epoxy embedded within said woven fibrous sleeve; and
said woven fibrous sleeve having an outer face circumferentially embedded against said central surface by application of outward radial forces from said central axis and bonded by said two-part epoxy.

19. A hybrid baseball bat of claim 18 where the flexible rod consists of, but not limited to, high strength carbon fiber rod, high tensile thermoplastic rods, fiberglass strengthened thermoplastics, thermoplastic elastomers, thermoset and wood.

20. The materials of claim 19 consists of vibration dampening/performance and/or strength enhancing materials.
